(19) United States
(12) Patent Application Publication
(10) Pub. No.: US 2015/0365195 A1
(43) Pub. Date: Dec. 17, 2015

(54) INTERLEAVING IN OFDMA DATA TONE PLANS

(71) Applicant: QUALCOMM Incorporated, San Diego, CA (US)

(72) Inventors: Lin Yang, San Diego, CA (US); Jialing Li Chen, San Diego, CA (US); Bin Tian, San Diego, CA (US); Sameer Vermani, San Diego, CA (US); Rahul Tandra, San Diego, CA (US)

(21) Appl. No.: 14/740,125

(22) Filed: Jun. 15, 2015

Related U.S. Application Data
(60) Provisional application No. 62/012,895, filed on Jun. 16, 2014.
(60) Provisional application No. 62/039,788, filed on Aug. 20, 2014.

(51) Int. Cl. H04L 1/00; H04L 5/00

(52) U.S. Cl. CPC H04L 1/0071; H04L 5/0044; H04L 5/0007

(57) ABSTRACT

Methods and techniques for interleaving orthogonal frequency division multiple access (OFDMA) data are disclosed. An apparatus includes an interleaver configured to interleave encoded data for at least one of a 72, 120, or 312 data tone allocation. The interleaver is further configured to generate a series of interleaved bits, for transmission based on the interleaved encoded data. The interleaver includes one or more stream interleavers corresponding to one or more spatial streams. The one or more stream interleavers are further configured to interleave the encoded data and generate the series of interleaved bits. The apparatus further includes a transmission circuit configured to transmit the series of interleaved bits via the one or more spatial streams.

### PRIORITY CLAIM

This application claims the benefit of U.S. Provisional Application No. 62/012,895, filed Jun. 16, 2014, and U.S. Provisional Application No. 62/039,788, filed Aug. 20, 2014, both of which are hereby incorporated herein by reference in their entirety.

### FIELD

The present disclosure is generally related to interleaving parameters for orthogonal frequency-division multiple access (OFDMA) data tone plans.

### DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Various wireless protocols and standards can be available for use by wireless telephones and other wireless devices. For example, Institute of Electrical and Electronics Engineers (IEEE) 802.11, commonly referred to as “Wi-Fi,” is a standardized set of wireless local area network (WLAN) communication protocols. In Wi-Fi protocols, data transmitted between wireless devices can be communicated according to orthogonal frequency-division multiplexing (OFDM). In OFDM packets are typically transmitted by a source device to a specific destination device.

### SUMMARY

DensiFi is an IEEE 802.11 study group (SG) to explore potential updates and revisions to Wi-Fi standards to improve efficiency and operational performance in certain use cases. Orthogonal frequency-division multiple access (OFDMA) is a type of system design that can be used for DensiFi to improve performance. OFDMA is a multi-user version of OFDM in which different tones (e.g., frequency ranges or “subcarriers”) are allocated on a per-user basis. Flexible OFDMA data tone plan designs can improve performance. For example, OFDMA can use 12 data tones per sub-band, 36 data tones per sub-band, 72 data tones per sub-band, 120 data tones per sub-band, 156 data tones per sub-band, or 312 data tones per sub-band.

To incorporate OFDMA into Wi-Fi, various interleaving parameters and designs can be used. The present disclosure provides interleaving parameters for OFDMA data tone plans for use with a wireless communication (e.g., IEEE 802.11) system.

In a particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 12 data tone block, an interleaver depth of 2, 3, 4, or 6, interleaved rotation indexes of 0, 2, 1, or 3 for up to four spatial streams, and a base subcarrier rotation of 1, 2, 3, 4, 5, 6, or 7. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 12 data tone block, using an interleaver depth of 2, 3, 4, or 6, using interleaved rotation indexes of 0, 2, 1, or 3 for up to four spatial streams, and using a base subcarrier rotation of 1, 2, 3, 4, 5, 6, or 7. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 12 data tone block, using an interleaver depth of 2, 3, 4, or 6, using interleaved rotation indexes of 0, 2, 1, or 3 for up to four spatial streams, and using a base subcarrier rotation of 1, 2, 3, 4, 5, 6, or 7. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 12 data tone block, using an interleaver depth of 2, 3, 4, or 6, using interleaved rotation indexes of 0, 2, 1, or 3 for up to four spatial streams, and using a base subcarrier rotation of 1, 2, 3, 4, 5, 6, or 7. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 36 data tone block, an interleaver depth of 2, 3, 4, 6, 9, 12, or 18, interleaved rotation indexes of 0, 2, 1, or 3 for up to four spatial streams, and a base subcarrier rotation of 1, 2, 3, 4, 5, 6, 7, 8, 9, 10, 11, 12, or 13. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 2, 1, or 3 for up to four spatial streams, and using a base subcarrier rotation of 1, 2, 3, 4, 5, 6, 7, 8, 9, 10, 11, 12, or 13. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 2, 1, or 3 for up to four spatial streams, and using a base subcarrier rotation of 1, 2, 3, 4, 5, 6, 7, 8, 9, 10, 11, 12, or 13. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 2, 1, or 3 for up to four spatial streams, and using a base subcarrier rotation of 1, 2, 3, 4, 5, 6, 7, 8, 9, 10, 11, 12, or 13. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 72 data tone block, an interleaver depth of 2, 3, 4, 6, 8, 9, 12, 18, 24, or 36, interleaved rotation indexes of 0, 2, 1, or 3 for up to four spatial streams, and a base subcarrier rotation of 1 any integer between an inclusive range of 1 and 22. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 2, 1, or 3 for up to four spatial streams, and using a base subcarrier rotation of any integer between an inclusive range of 1 and 22. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 2, 1, or 3 for up to four spatial streams, and using a base subcarrier rotation of any integer between an inclusive range of 1 and 22. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 2, 1, or 3 for up to four spatial streams, and using a base subcarrier rotation of any integer between an inclusive range of 1 and 22. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 120 data tone block, an interleaver depth of 2, 3, 4, 5, 6, 8, 10, 12, 15, 20, 24, 30, 40, or 60, interleaved rotation indexes of 0, 2, 1, or 3 for up to four spatial streams, and a base subcarrier rotation of 1 any integer between an inclusive range of 1 and 34. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 2, 1, or 3 for up to four spatial streams, and using a base subcarrier rotation of any integer between an inclusive range of 1 and 34. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 2, 1, or 3 for up to four spatial streams, and using a base subcarrier rotation of any integer between an inclusive range of 1 and 34. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 2, 1, or 3 for up to four spatial streams, and using a base subcarrier rotation of any integer between an inclusive range of 1 and 34. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 156 data tone block, an interleaver depth of 2, 3, 4, 6, 12, 13, 26, 39, 52, or 78, interleaved rotation indexes of 0, 2, 1, or 3 for up to four spatial streams, and a base subcarrier rotation of 1 any integer between an inclusive range of 1 and 43. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 2, 1, or 3 for up to four spatial streams, and using a base subcarrier rotation of any integer between an inclusive range of 1 and 43. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 2, 1, or 3 for up to four spatial streams, and using a base subcarrier rotation of any integer between an inclusive range of 1 and 43. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 2, 1, or 3 for up to four spatial streams, and using a base subcarrier rotation of any integer between an inclusive range of 1 and 43. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 312 data tone block, an interleaver depth of 2, 3, 4, 6, 8, 12, 13, 24, 26, 39, 52, 78, 104, 156, interleaved rotation indexes of 0, 2, 1, or 3 for up to four spatial streams, and a base subcarrier rotation of 1 any integer between an inclusive range of 1 and 82. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 2, 1, or 3 for up to four spatial streams, and using a base subcarrier rotation of any integer between an inclusive range of 1 and 82. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 2, 1, or 3 for up to four spatial streams, and using a base subcarrier rotation of any integer between an inclusive range of 1 and 82. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 2, 1, or 3 for up to four spatial streams, and using a base subcarrier rotation of any integer between an inclusive range of 1 and 82. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 12 data tone block, an interleaver depth of 2, 3, 4, or 6, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1, 2, 3, 4, 5, or 6. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 12 data tone block, using an interleaver depth of 2, 3, 4, or 6, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, or 6. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 12 data tone block, using an interleaver depth of 2, 3, 4, or 6, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, or 6. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 12 data tone block, using an interleaver depth of 2, 3, 4, or 6, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, or 6. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 36 data tone block, an interleaver depth of 2, 3, 4, 6, 9, 12, or 18, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1, 2, 3, 4, 5, 6, 7, 8, or 9. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, 6, 7, 8, or 9. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, 6, 7, 8, or 9. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 36 data tone block, using an interleaver depth of 2, 3, 4, 6, 9, 12, or 18, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, 6, 7, 8, or 9. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 72 data tone block, an interleaver depth of 2, 3, 4, 6, 8, 9, 12, 18, 24, or 36, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1 any integer between an inclusive range of 1 and 13. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 13. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 13. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 72 data tone block, using an interleaver depth of 2, 3, 4, 6, 8, 9, 12, 18, 24, or 36, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 13. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 120 data tone block, an interleaver depth of 2, 3, 4, 5, 6, 8, 10, 12, 15, 20, 24, 30, 40, or 60, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1 any integer between an inclusive range of 1 and 19. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 19. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 19. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 120 data tone block, using an interleaver depth of 2, 3, 4, 5, 6, 8, 10, 12, 15, 20, 24, 30, 40, or 60, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 19. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 156 data tone block, an interleaver depth of 2, 3, 4, 6, 12, 13, 26, 39, 52, or 78, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1 any integer between an inclusive range of 1 and 24. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 24. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 24. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 156 data tone block, using an interleaver depth of 2, 3, 4, 6, 12, 13, 26, 39, 52, or 78, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 24. The apparatus also includes means for transmitting the series of interleaved bits via the one or more spatial streams.

In another particular embodiment, an apparatus for wireless communication includes an interleaver configured to interleave encoded data and generate a series of interleaved bits for transmission based on the interleaved encoded data. The interleaver includes one or more stream interleavers corresponding to one or more spatial streams. The one or more stream interleavers include a 312 data tone block, an interleaver depth of 2, 3, 4, 6, 8, 12, 13, 24, 26, 39, 52, 78, 104, 156, interleaved rotation indexes of 0, 4, 2, 6, 1, 5, 3, or 7 for 5, 6, 7, or 8 spatial streams or interleaved rotation indexes to maximize (or increase) an average subcarrier distance of adjacent streams for 5, 6, 7, or 8 spatial streams, and a base subcarrier rotation of 1 any integer between an inclusive range of 1 and 43. The apparatus also includes a transmission circuit configured to transmit the series of interleaved bits via the one or more spatial streams.

In another particular embodiment, a method includes interleaving encoded data and generating a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 43. The method also includes transmitting the series of interleaved bits via the one or more spatial streams.

In another particular embodiment, a non-transitory computer-readable medium includes instructions that, when executed by a processor, cause the processor to interleave encoded data and generate a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 43. The instructions are also executable to cause the processor to transmit the series of interleaved bits via the one or more spatial streams.

In another particular embodiment, an apparatus for wireless communication includes means for interleaving encoded data and means for generating a series of interleaved bits for transmission for one or more spatial streams. Interleaving for the one or more spatial streams includes using a 312 data tone block, using an interleaver depth of 2, 3, 4, 6, 8, 12, 13, 24, 26, 39, 52, 78, 104, 156, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 43. The apparatus also includes means for transmitting the series of interleaved bits via the one or more spatial streams.

In various embodiments, the interleaver can be configured to use a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

In various embodiments, said means for generating can include means for using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

Another aspect provides another apparatus for wireless communication. The apparatus includes an interleaver configured to interleave encoded data for at least one of a 72, 120, or 312 data tone allocation. The interleaver is further configured to generate a series of interleaved bits, for transmission based on the interleaved encoded data. The interleaver includes one or more stream interleavers corresponding to one or more spatial streams. The one or more stream interleavers are configured to interleave the encoded data and generate the series of interleaved bits by using an interleaver depth of: 2, 3, 4, 6, 8, 9, 12, 18, 24, or 36 for the 72 data tone allocation; 2, 3, 4, 5, 6, 8, 10, 12, 15, 20, 24, 30, 40, or 60 for the 120 data tone allocation; or 2, 3, 4, 6, 8, 12, 13, 24, 26, 39, 52, 78, 104, or 156 for the 312 data tone allocation. The one or more stream interleavers are further configured to interleave the encoded data and generate the series of interleaved bits by using an interleaved rotation index of at least one of [0, 2, 1, 3], [0, 4, 2, 6, 1, 5, 3, 7], or [0, 5, 2, 7, 3, 6, 1, 4]. The one or more stream interleavers are further configured to interleave the encoded data and generate the series of interleaved bits by using a base subcarrier rotation of: any integer within the inclusive range between 1 and 22 for the 72 data tone allocation; any integer within the inclusive range between 1 and 34 for the 120 data tone allocation; or any integer within the inclusive range between 1 and 82 for the 312 data tone allocation. The apparatus further includes a transmission circuit configured to transmit the series of interleaved bits via the one or more spatial streams.

In various embodiments, the transmission circuit includes one or more antennas. In various embodiments, the interleaver includes a stream parser configured to parse the encoded data to each of the one or more stream interleavers. In various embodiments, each 72, 120, or 312 data tone allocation is allocated to an individual destination device.

In various embodiments, the one or more stream interleavers include use an interleaved rotation index of [0, 2, 1, 3] for up to four spatial streams, and [0, 4, 2, 6, 1, 5, 3, 7] for 5, 6, 7, or 8 spatial streams. In various embodiments, the one or more stream interleavers include use an interleaved rotation index of [0, 2, 1, 3] for up to four spatial streams, and [0, 5, 2, 7, 3, 6, 1, 4] for 5, 6, 7, or 8 spatial streams. In various embodiments, the one or more stream interleavers include interleaved rotation indices that maximize an average subcarrier distance of adjacent streams.

In various embodiments, said interleaver is further configured to use a low density parity check (LDPC) tone mapping distance (DTM) of: 4 or 6 for the 72 data tone allocation; 6 or 8 for the 120 data tone allocation; or 12 or 13 for the 312 data tone allocation. In various embodiments, the one or more stream interleavers include an interleaver depth of: 12 or 18 for the 72 data tone allocation; 15 or 20 for the 120 data tone allocation; or 12, 13, 24, or 26 for the 312 data tone allocation. In various embodiments, the one or more stream interleavers include a base subcarrier rotation for up to four spatial streams of: any integer within the inclusive range between 16 and 20 for the 72 data tone allocation; any integer within the inclusive range between 28 and 32 for the 120 data tone allocation; or any integer within the inclusive range between 76 and 80 for the 312 data tone allocation.

In various embodiments, the one or more stream interleavers include a base subcarrier rotation for up to four spatial streams of any integer within the inclusive range between 1 and 22 for the 72 data tone allocation, any integer within the inclusive range between 1 and 34 for the 120 data tone allocation, or any integer within the inclusive range between 1 and 82 for the 312 data tone allocation. In various embodiments, the one or more stream interleavers include a base subcarrier rotation for 5, 6, 7, or 8 spatial streams of any integer within the inclusive range between 1 and 13 for the 72 data tone allocation, any integer within the inclusive range between 1 and 19 for the 120 data tone allocation, or any integer within the inclusive range between 1 and 43 for the 312 data tone allocation.

In various embodiments, the one or more stream interleavers include a base subcarrier rotation for 5, 6, 7, or 8 spatial streams of: any integer within the inclusive range between 7 and 11 for the 72 data tone allocation; any integer within the inclusive range between 13 and 17 for the 120 data tone allocation; or any integer within the inclusive range between 37 and 41 for the 312 data tone allocation. In various embodiments, the one or more stream interleavers include a base subcarrier rotation for up to four spatial streams of: 18 for the 72 data tone allocation; 30 for the 120 data tone allocation; or 78 for the 312 data tone allocation. In various embodiments, the one or more stream interleavers include a base subcarrier rotation for 5, 6, 7, or 8 spatial streams of: 9 for the 72 data tone allocation; 15 for the 120 data tone allocation; or 39 for the 312 data tone allocation.

In various embodiments, the interleaver is configured to exclude a modulation and coding scheme (MCS) number 5 when using 7 or 8 spatial streams, exclude an MCS number 6 when using 7 spatial streams, and exclude an MCS number 8 when using 8 spatial steams, for the 312 data tone allocation. In various embodiments, the interleaver is configured to use a modulation and coding scheme (MCS) exclusion of MCS8 and 8 spatial steams for the 312 data tone allocation.

Another aspect provides another method of wireless communication. The method includes interleaving encoded data for at least one of a 72, 120, or 312 data tone allocation. The medium can further include code that, when executed, causes the apparatus to using generating a series of interleaved bits for transmission for one or more spatial streams. Interleaving for the one or more spatial streams includes using an interleaver depth of: 2, 3, 4, 6, 8, 9, 12, 18, 24, or 36 for the 72 data tone allocation; 2, 3, 4, 5, 6, 8, 10, 12, 15, 20, 24, 30, 40, or 60 for the 120 data tone allocation; or 2, 3, 4, 6, 8, 12, 13, 24, 26, 39, 52, 78, 104, or 156 for the 312 data tone allocation. Interleaving for the one or more spatial streams further includes using an interleaved rotation index of at least one of [0, 2, 1, 3], [0, 4, 2, 6, 1, 5, 3, 7], or [0, 5, 2, 7, 3, 6, 1, 4]. Interleaving for the one or more spatial streams further includes using a base subcarrier rotation of: any integer within the inclusive range between 1 and 22 for the 72 data tone allocation; any integer within the inclusive range between 1 and 34 for the 120 data tone allocation; or any integer within the inclusive range between 1 and 82 for the 312 data tone allocation. The method further includes transmitting the series of interleaved bits via the one or more spatial streams.

In various embodiments, transmitting includes transmitting via one or more antennas. In various embodiments, the method includes parsing the encoded data to each of the one or more stream interleavers. In various embodiments, each 72, 120, or 312 data tone allocation is allocated to an individual destination device.

In various embodiments, interleaving for the one or more spatial streams includes using an interleaved rotation index of [0, 2, 1, 3] for up to four spatial streams, and [0, 4, 2, 6, 1, 5, 3, 7] for 5, 6, 7, or 8 spatial streams. In various embodiments, interleaving for the one or more spatial streams includes using an interleaved rotation index of [0, 2, 1, 3] for up to four spatial streams, and [0, 5, 2, 7, 3, 6, 1, 4] for 5, 6, 7, or 8 spatial streams. In various embodiments, interleaving for the one or more spatial streams includes using interleaved rotation indices that maximize an average subcarrier distance of adjacent streams.

In various embodiments, the method further includes using a low density parity check (LDPC) tone mapping distance (DTM) of: 4 or 6 for the 72 data tone allocation; 6 or 8 for the 120 data tone allocation; or 12 or 13 for the 312 data tone allocation. In various embodiments, interleaving for the one or more spatial streams includes using an interleaver depth of: 12 or 18 for the 72 data tone allocation; 15 or 20 for the 120 data tone allocation; or 12, 13, 24, or 26 for the 312 data tone allocation. In various embodiments, interleaving for the one or more spatial streams includes using a base subcarrier rotation for up to four spatial streams of: any integer within the inclusive range between 16 and 20 for the 72 data tone allocation; any integer within the inclusive range between 28 and 32 for the 120 data tone allocation; or any integer within the inclusive range between 76 and 80 for the 312 data tone allocation.

In various embodiments, interleaving for the one or more spatial streams includes using a base subcarrier rotation for up to four spatial streams of any integer within the inclusive range between 1 and 22 for the 72 data tone allocation, any integer within the inclusive range between 1 and 34 for the 120 data tone allocation, or any integer within the inclusive range between 1 and 82 for the 312 data tone allocation. In various embodiments, interleaving for the one or more spatial streams includes using a base subcarrier rotation for 5, 6, 7, or 8 spatial streams of any integer within the inclusive range between 1 and 13 for the 72 data tone allocation, any integer within the inclusive range between 1 and 19 for the 120 data tone allocation, or any integer within the inclusive range between 1 and 43 for the 312 data tone allocation.

In various embodiments, interleaving for the one or more spatial streams includes using a base subcarrier rotation for 5, 6, 7, or 8 spatial streams of: any integer within the inclusive range between 7 and 11 for the 72 data tone allocation; any integer within the inclusive range between 13 and 17 for the 120 data tone allocation; or any integer within the inclusive range between 37 and 41 for the 312 data tone allocation. In various embodiments, interleaving for the one or more spatial streams includes using a base subcarrier rotation for up to four spatial streams of: 18 for the 72 data tone allocation; 30 for the 120 data tone allocation; or 78 for the 312 data tone allocation. In various embodiments, interleaving for the one or more spatial streams includes using a base subcarrier rotation for 5, 6, 7, or 8 spatial streams of: 9 for the 72 data tone allocation; 15 for the 120 data tone allocation; or 39 for the 312 data tone allocation.

In various embodiments, the method can further include excluding a modulation and coding scheme (MCS) number 5 when using 7 or 8 spatial streams, excluding an MCS number 6 when using 7 spatial streams, and excluding an MCS number 8 when using 8 spatial steams, for the 312 data tone allocation. In various embodiments, the method can further include using a modulation and coding scheme (MCS) exclusion of MCS8 and 8 spatial steams for the 312 data tone allocation.

Another aspect provides another non-transitory computer-readable medium. The medium includes code that, when executed, causes an apparatus to interleave encoded data for at least one of a 72, 120, or 312 data tone allocation. The medium further includes code that, when executed, causes the apparatus to generate a series of interleaved bits for transmission for one or more spatial streams. Interleaving for the one or more spatial streams includes using an interleaver depth of: 2, 3, 4, 6, 8, 9, 12, 18, 24, or 36 for the 72 data tone allocation; 2, 3, 4, 5, 6, 8, 10, 12, 15, 20, 24, 30, 40, or 60 for the 120 data tone allocation; or 2, 3, 4, 6, 8, 12, 13, 24, 26, 39, 52, 78, 104, or 156 for the 312 data tone allocation. Interleaving for the one or more spatial streams further includes using an interleaved rotation index of at least one of [0, 2, 1, 3], [0, 4, 2, 6, 1, 5, 3, 7], or [0, 5, 2, 7, 3, 6, 1, 4]. Interleaving for the one or more spatial streams further includes using a base subcarrier rotation of: any integer within the inclusive range between 1 and 22 for the 72 data tone allocation; any integer within the inclusive range between 1 and 34 for the 120 data tone allocation; or any integer within the inclusive range between 1 and 82 for the 312 data tone allocation. The medium further includes code that, when executed, causes the apparatus to transmit the series of interleaved bits via the one or more spatial streams.

In various embodiments, transmitting includes transmitting via one or more antennas. In various embodiments, the method includes parsing the encoded data to each of the one or more stream interleavers. In various embodiments, each 72, 120, or 312 data tone allocation is allocated to an individual destination device.

In various embodiments, interleaving for the one or more spatial streams includes using an interleaved rotation index of [0, 2, 1, 3] for up to four spatial streams, and [0, 4, 2, 6, 1, 5, 3, 7] for 5, 6, 7, or 8 spatial streams. In various embodiments, interleaving for the one or more spatial streams includes using an interleaved rotation index of [0, 2, 1, 3] for up to four spatial streams, and [0, 5, 2, 7, 3, 6, 1, 4] for 5, 6, 7, or 8 spatial streams. In various embodiments, interleaving for the one or more spatial streams includes using interleaved rotation indices that maximize an average subcarrier distance of adjacent streams.

In various embodiments, the medium can further include code that, when executed, causes the apparatus to using a low density parity check (LDPC) tone mapping distance (DTM) of: 4 or 6 for the 72 data tone allocation; 6 or 8 for the 120 data tone allocation; or 12 or 13 for the 312 data tone allocation. In various embodiments, interleaving for the one or more spatial streams includes using an interleaver depth of: 12 or 18 for the 72 data tone allocation; 15 or 20 for the 120 data tone allocation; or 12, 13, 24, or 26 for the 312 data tone allocation. In various embodiments, interleaving for the one or more spatial streams includes using a base subcarrier rotation for up to four spatial streams of: any integer within the inclusive range between 16 and 20 for the 72 data tone allocation; any integer within the inclusive range between 28 and 32 for the 120 data tone allocation; or any integer within the inclusive range between 76 and 80 for the 312 data tone allocation.

In various embodiments, interleaving for the one or more spatial streams includes using a base subcarrier rotation for up to four spatial streams of any integer within the inclusive range between 1 and 22 for the 72 data tone allocation, any integer within the inclusive range between 1 and 34 for the 120 data tone allocation, or any integer within the inclusive range between 1 and 82 for the 312 data tone allocation. In various embodiments, interleaving for the one or more spatial streams includes using a base subcarrier rotation for 5, 6, 7, or 8 spatial streams of any integer within the inclusive range between 1 and 13 for the 72 data tone allocation, any integer within the inclusive range between 1 and 19 for the 120 data tone allocation, or any integer within the inclusive range between 1 and 43 for the 312 data tone allocation.

In various embodiments, interleaving for the one or more spatial streams includes using a base subcarrier rotation for 5, 6, 7, or 8 spatial streams of: any integer within the inclusive range between 7 and 11 for the 72 data tone allocation; any integer within the inclusive range between 13 and 17 for the 120 data tone allocation; or any integer within the inclusive range between 37 and 41 for the 312 data tone allocation. In various embodiments, interleaving for the one or more spatial streams includes using a base subcarrier rotation for up to four spatial streams of: 18 for the 72 data tone allocation; 30 for the 120 data tone allocation; or 78 for the 312 data tone allocation. In various embodiments, interleaving for the one or more spatial streams includes using a base subcarrier rotation for 5, 6, 7, or 8 spatial streams of: 9 for the 72 data tone allocation; 15 for the 120 data tone allocation; or 39 for the 312 data tone allocation.

In various embodiments, the medium can further include code that, when executed, causes the apparatus to excluding a modulation and coding scheme (MCS) number 5 when using 7 or 8 spatial streams, excluding an MCS number 6 when using 7 spatial streams, and excluding an MCS number 8 when using 8 spatial steams, for the 312 data tone allocation. In various embodiments, the medium can further include code that, when executed, causes the apparatus to using a modulation and coding scheme (MCS) exclusion of MCS8 and 8 spatial steams for the 312 data tone allocation.

Another aspect provides another apparatus for wireless communication. The apparatus includes means for interleaving encoded data for at least one of a 72, 120, or 312 data tone allocation. The apparatus further includes means for generating a series of interleaved bits for transmission for one or more spatial streams Interleaving for the one or more spatial streams includes means for using an interleaver depth of: 2, 3, 4, 6, 8, 9, 12, 18, 24, or 36 for the 72 data tone allocation; 2, 3, 4, 5, 6, 8, 10, 12, 15, 20, 24, 30, 40, or 60 for the 120 data tone allocation; or 2, 3, 4, 6, 8, 12, 13, 24, 26, 39, 52, 78, 104, or 156 for the 312 data tone allocation. Interleaving for the one or more spatial streams further includes means for using an interleaved rotation index of at least one of [0, 2, 1, 3], [0, 4, 2, 6, 1, 5, 3, 7], or [0, 5, 2, 7, 3, 6, 1, 4]. Interleaving for the one or more spatial streams further includes means for using a base subcarrier rotation of: any integer within the inclusive range between 1 and 22 for the 72 data tone allocation; any integer within the inclusive range between 1 and 34 for the 120 data tone allocation; or any integer within the inclusive range between 1 and 82 for the 312 data tone allocation. The apparatus further includes means for transmitting the series of interleaved bits via the one or more spatial streams.

In various embodiments, means for transmitting includes means for transmitting via one or more antennas. In various embodiments, the apparatus includes parsing the encoded data to each of the one or more stream interleavers. In various embodiments, each 72, 120, or 312 data tone allocation is allocated to an individual destination device.

In various embodiments, means for interleaving for the one or more spatial streams includes means for using an interleaved rotation index of [0, 2, 1, 3] for up to four spatial streams, and [0, 4, 2, 6, 1, 5, 3, 7] for 5, 6, 7, or 8 spatial streams. In various embodiments, means for interleaving for the one or more spatial streams includes means for using an interleaved rotation index of [0, 2, 1, 3] for up to four spatial streams, and [0, 5, 2, 7, 3, 6, 1, 4] for 5, 6, 7, or 8 spatial streams. In various embodiments, means for interleaving for the one or more spatial streams includes means for using interleaved rotation indices that maximize an average subcarrier distance of adjacent streams.

In various embodiments, the apparatus further includes means for using a low density parity check (LDPC) tone mapping distance (DTM) of: 4 or 6 for the 72 data tone allocation; 6 or 8 for the 120 data tone allocation; or 12 or 13 for the 312 data tone allocation. In various embodiments, means for interleaving for the one or more spatial streams includes means for using an interleaver depth of: 12 or 18 for the 72 data tone allocation; 15 or 20 for the 120 data tone allocation; or 12, 13, 24, or 26 for the 312 data tone allocation. In various embodiments, means for interleaving for the one or more spatial streams includes means for using a base subcarrier rotation for up to four spatial streams of: any integer within the inclusive range between 16 and 20 for the 72 data tone allocation; any integer within the inclusive range between 28 and 32 for the 120 data tone allocation; or any integer within the inclusive range between 76 and 80 for the 312 data tone allocation.

In various embodiments, means for interleaving for the one or more spatial streams includes means for using a base subcarrier rotation for up to four spatial streams of any integer within the inclusive range between 1 and 22 for the 72 data tone allocation, any integer within the inclusive range between 1 and 34 for the 120 data tone allocation, or any integer within the inclusive range between 1 and 82 for the 312 data tone allocation. In various embodiments, means for interleaving for the one or more spatial streams includes means for using a base subcarrier rotation for 5, 6, 7, or 8 spatial streams of any integer within the inclusive range between 1 and 13 for the 72 data tone allocation, any integer within the inclusive range between 1 and 19 for the 120 data tone allocation, or any integer within the inclusive range between 1 and 43 for the 312 data tone allocation. In various embodiments, means for interleaving for the one or more spatial streams includes means for using a base subcarrier rotation for 5, 6, 7, or 8 spatial streams of: any integer within the inclusive range between 7 and 11 for the 72 data tone allocation; any integer within the inclusive range between 13 and 17 for the 120 data tone allocation; or any integer within the inclusive range between 37 and 41 for the 312 data tone allocation. In various embodiments, means for interleaving for the one or more spatial streams includes means for using a base subcarrier rotation for up to four spatial streams of: 18 for the 72 data tone allocation; 30 for the 120 data tone allocation; or 78 for the 312 data tone allocation. In various embodiments, means for interleaving for the one or more spatial streams includes means for using a base subcarrier rotation for 5, 6, 7, or 8 spatial streams of: 9 for the 72 data tone allocation; 15 for the 120 data tone allocation; or 39 for the 312 data tone allocation.

In various embodiments, the apparatus can further include means for excluding a modulation and coding scheme (MCS) number 5 when using 7 or 8 spatial streams, excluding an MCS number 6 when using 7 spatial streams, and excluding an MCS number 8 when using 8 spatial steams, for the 312 data tone allocation. In various embodiments, the apparatus can further include means for using a modulation and coding scheme (MCS) exclusion of MCS8 and 8 spatial steams for the 312 data tone allocation.

One particular advantage provided by at least one of the disclosed embodiments is enhanced OFDMA data interleaving. Other parameters, such as interleaver parameters for “unknown” interleavers, can be dynamically determined from “known” parameters of “known” interleavers. Other aspects, advantages, and features of the present disclosure will become apparent after review of the entire application, including the following sections: Brief Description of the Drawings, Detailed Description, and the Claims.

In various embodiments, the interleaver can be configured to use a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

In various embodiments, said means for generating can include means for using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

### BRIEF DESCRIPTION OF THE DRAWINGS

FIG. 1 is a diagram to illustrate a particular embodiment of a system that is operable to use interleaving parameters for orthogonal frequency-division multiple access (OFDMA) tone plans;

FIG. 2 is a diagram to illustrate a particular embodiment of a multiple-input-multiple-output (MIMO) system that can be implemented in wireless devices to transmit and receive wireless communications;

FIG. 3 is a chart illustrating candidate interleaver parameters for different numbers of data tones;

FIG. 4A is a chart illustrating a low density parity check (LDPC) tone mapping distance for different numbers of data tones;

FIG. 4B is a chart illustrating modulation and coding scheme (MCS) validity of the interleaver parameters;

FIG. 4C is another chart illustrating a low density parity check (LDPC) tone mapping distance for different numbers of data tones;

FIG. 5 is a flowchart illustrating a particular embodiment of a method for interleaving OFDMA data;

FIG. 6 is a flowchart illustrating another particular embodiment of a method for interleaving OFDMA data;

FIG. 7 is a flowchart illustrating another particular embodiment of a method for interleaving OFDMA data;

FIG. 8 is a flowchart illustrating another particular embodiment of a method for interleaving OFDMA data;

FIG. 9 is a flowchart illustrating another particular embodiment of a method for interleaving OFDMA data;

FIG. 10 is a flowchart illustrating another particular embodiment of a method for interleaving OFDMA data;

FIG. 11 is a flowchart illustrating another particular embodiment of a method for interleaving OFDMA data;

FIG. 12 is a flowchart illustrating another particular embodiment of a method for interleaving OFDMA data;

FIG. 13 is a flowchart illustrating another particular embodiment of a method for interleaving OFDMA data;

FIG. 14 is a flowchart illustrating another particular embodiment of a method for interleaving OFDMA data;

FIG. 15 is a flowchart illustrating another particular embodiment of a method for interleaving OFDMA data;

FIG. 16 is a flowchart illustrating another particular embodiment of a method for interleaving OFDMA data;

FIG. 17 is a diagram of a wireless device that is operable to support various embodiments of one or more methods, systems, apparatuses, and/or computer-readable media disclosed herein; and

FIG. 18 is a flowchart illustrating another particular embodiment of a method for interleaving OFDMA data.

### DETAILED DESCRIPTION

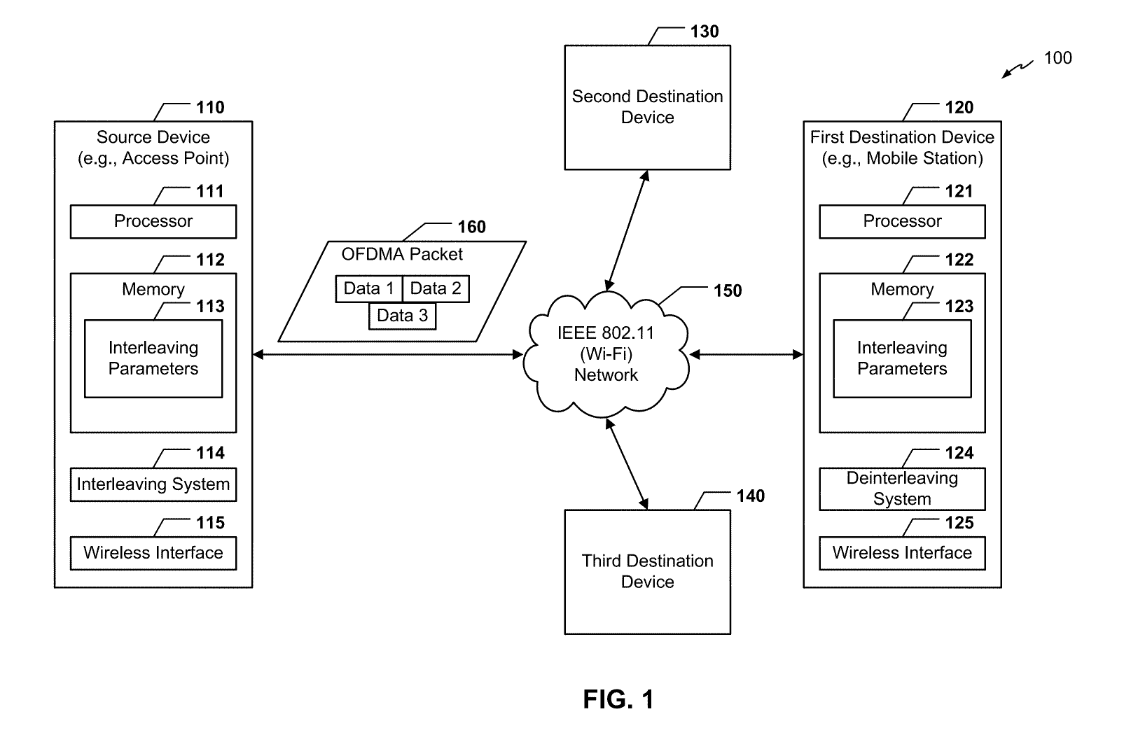

Referring to FIG. 1, a system that is operable to generate interleaving parameters for orthogonal frequency-division multiple access (OFDMA) tone plans is shown and generally designated 100. The system 100 includes a first device (e.g., a source device) 110 configured to wirelessly communicate with a plurality of other devices (e.g., destination devices) 120, 130, and 140 via a wireless network 150. In alternate embodiments, a different number of source devices destination devices can be present in the system 100.

In a particular embodiment, the wireless network 150 is an Institute of Electrical and Electronics Engineers (IEEE) 802.11 wireless network (e.g., a Wi-Fi network). For example, the wireless network 150 can operate in accordance with an IEEE 802.11 standard. In a particular embodiment, the wireless network 150 supports multiple access communication. For example, the wireless network 150 can support communication of a single packet 160 to each of the destination devices 120, 130, and 140, where the single packet 160 includes individual data portions directed to each of the destination devices. In one example, the packet 160 can be an OFDMA packet, as further described herein.

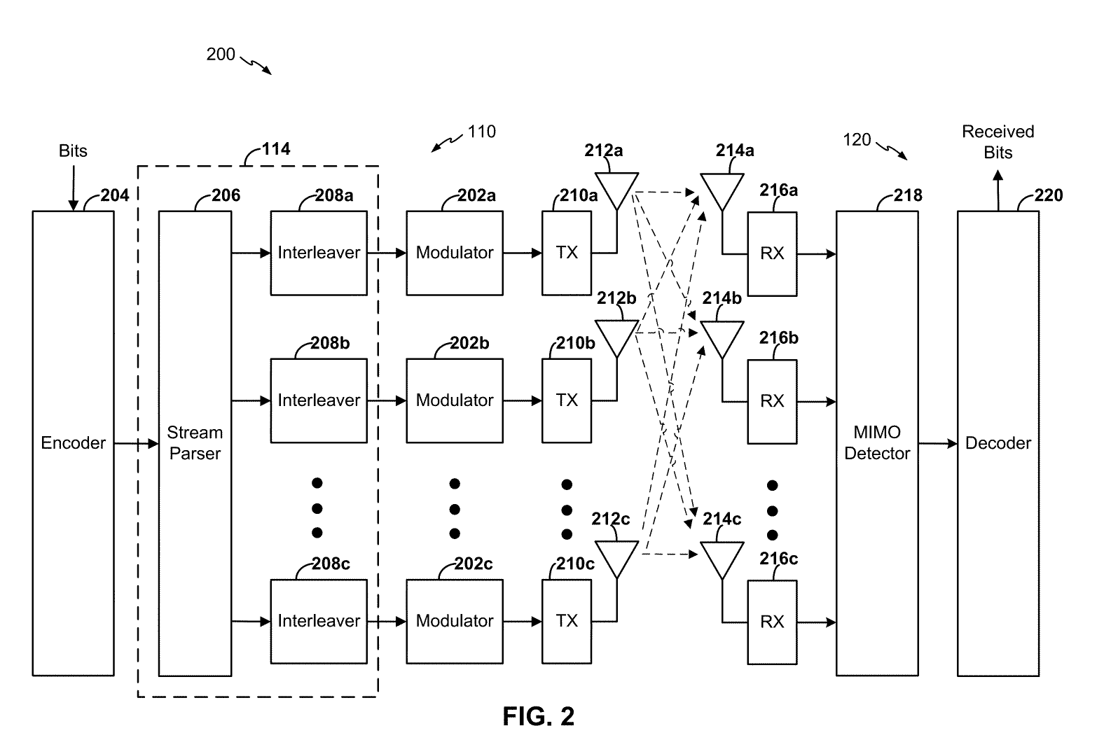

The source device 110 can be an access point (AP) or other device configured to generate and transmit multiple access packet(s) to multiple destination devices. In a particular embodiment, the source device 110 includes a processor 111 (e.g., a central processing unit (CPU), a digital signal processor (DSP), a network processing unit (NPU), etc.), a memory 112 (e.g., a random access memory (RAM), a read-only memory (ROM), etc.), and a wireless interface 115 configured to send and receive data via the wireless network 150. The memory 112 can store binary convolutional code (BCC) interleaving parameters 113 used by an interleaving system 114 to interleave data according to the techniques described with respect to an interleaving system 114 of FIG. 2.

As used herein, a “tone” can represent a frequency or set of frequencies (e.g., a frequency range) within which data can be communicated. A tone can alternately be referred to as a subcarrier. A “tone” can thus be a frequency domain unit, and a packet can span multiple tones. In contrast to tones, a “symbol” can be a time domain unit, and a packet can span (e.g., include) multiple symbols, each symbol having a particular duration. A wireless packet can thus be visualized as a two-dimensional structure that spans a frequency range (e.g., tones) and a time period (e.g., symbols).

As an example, a wireless device can receive a packet via a 20 megahertz (MHz) wireless channel (e.g., a channel having 20 MHz bandwidth). The wireless device can perform a 64-point fast Fourier transform (FFT) to determine 64 tones in the packet. A subset of the tones can be considered “useable” and the remaining tones can be considered “unusable” (e.g., can be guard tones, direct current (DC) tones, etc.). To illustrate, 56 of the 64 tones can be useable, including 52 data tones and 4 pilot tones. As another example, there can be 48 data tones and 4 pilot tones. It should be noted that the aforementioned channel bandwidths, transforms, and tone plans are for example. In alternate embodiments, different channel bandwidths (e.g., 5 MHz, 6 MHz, 6.5 MHz, 40 MHz, 80 MHz, etc.), different transforms (e.g., 256-point FFT, 1024-point FFT, etc.), and/or different tone plans can be used.

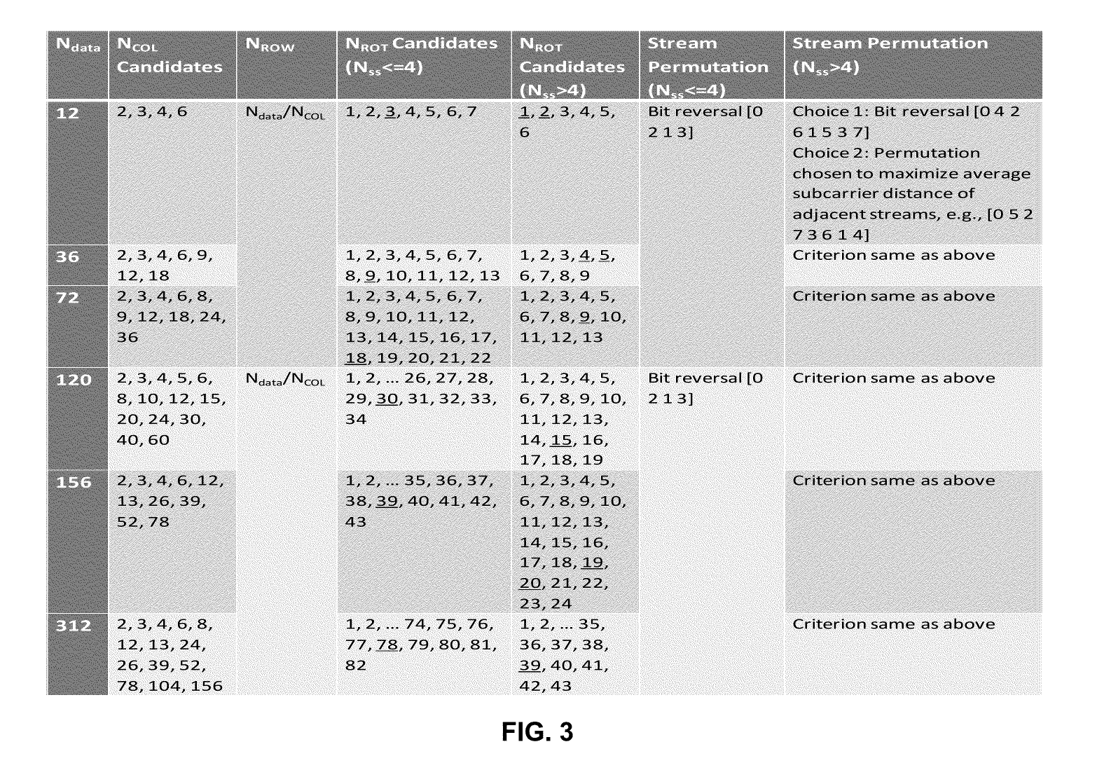

In a particular embodiment, a packet can include different block sizes (e.g., a different number of data tones per sub-band) that are transmitted over one or more spatial streams. For example, the packet can include 12 data tones per sub-band, 36 data tones per sub-band, 72 data tones per sub-band, 120 data tones per sub-band, 156 data tones per sub-band, or 312 data tones per sub-band. Interleave depths, interleave rotation indexes, and base subcarrier rotations combinations can be provided for each block size according to the chart in FIG. 3.

In a particular embodiment, the interleaving parameters 113 can be used by the interleaving system 114 during generation of the multiple access packet 160 to determine which data tones of the packet 160 are assigned to individual destination devices. For example, the packet 160 can include distinct sets of tones allocated to each individual destination device 120, 130, and 140. To illustrate, the packet 160 can utilize interleaved tone allocation.

The destination devices 120, 130, and 140 can each include a processor (e.g., a processor 121), a memory (e.g., a memory 122), and a wireless interface (e.g., a wireless interface 125). The destination devices 120, 130, and 140 can also each include a deinterleaving system 124 configured to deinterleave packets (e.g., single access packets or multiple access packets), as described with reference to a MIMO detector 218 of FIG. 2. In one example, the memory 122 can store interleaving parameters 123 identical to the interleaving parameters 113.

During operation, the source device 110 can generate and transmit the packet 160 to each of the destination devices 120, 130, and 140 via the wireless network 150. The packet 160 can include distinct sets of data tones that are allocated to each individual destination device according to an interleaved pattern.

The system 100 of FIG. 1 can thus provide OFDMA data tone interleaving parameters for use by source devices and destination devices to communicate over an IEEE 802.11 wireless network. For example, the interleaving parameters 113, 123 (or portions thereof) can be stored in a memory of the source and destination devices, as shown, can be standardized by a wireless standard (e.g., an IEEE 802.11 standard), etc. It should be noted that various data tone plans described herein can be applicable for both downlink (DL) as well as uplink (UL) OFDMA communication.

For example, the source device 110 (e.g., an access point) can receive signal(s) via the wireless network 150. The signal(s) can correspond to an uplink packet. In the packet, distinct sets of tones can be allocated to, and carry uplink data transmitted by, each of the destination devices (e.g., mobile stations) 120, 130, and 140.

Referring to FIG. 2, a particular illustrative embodiment of a multiple-input-multiple-output (MIMO) system 200 that can be implemented in wireless devices, such as the wireless device of FIG. 1, to transmit and receive wireless communications is shown. The system 200 includes the first device 110 of FIG. 1 and the destination device 120 of FIG. 1.

The first device 110 includes an encoder 204, the interleaving system 114, a plurality of modulators 202a-202c, a plurality of transmission (TX) circuits 210a-210c, and a plurality of antennas 212a-212c. The destination device 120 includes a plurality of antennas 214a-214c, a plurality of receive (RX) circuits 216a-216c, a MIMO detector 218, and a decoder 220.

A bit sequence can be provided to the encoder 204. The encoder 204 can be configured to encode the bit sequence. For example, the encoder 204 can be configured to apply a forward error correcting (FEC) code to the bit sequence. The FEC code can be a block code, a convolutional code (e.g., a binary convolutional code), etc. The encoded bit sequence can be provided to the interleaving system 114.

The interleaving system 114 can include a stream parser 206 and a plurality of spatial stream interleavers 208a-208c. The stream parser 206 can be configured to parse the encoded bit stream from the encoder 204 to the plurality of spatial stream interleavers 208a-208c.

Each interleaver 208a-208c can be configured to perform frequency interleaving. For example, the stream parser 206 can output blocks of coded bits per symbol for each spatial stream. Each block can be interleaved by a corresponding interleaver 208a-208c that writes to rows and reads out columns. The number of columns (N_{COL}) or the interleaver depth, can be based on the number of data tones (N_{data}), as described with respect to the table of FIG. 3. The number of rows (N_{ROW}) can be a function of the number of columns (N_{COL}) and the number of data tones (N_{data}). For example, the number of rows (N_{ROW}) can be equal to the number of data tones (N_{data}) divided by the number of columns (N_{COL}) (e.g., N_{ROW}=N_{data}/N_{COL} or N_{ROW}=N_{data}/N_{COL}*N_{BPSCS}, where N_{BPSCS} is the number of coded bits per subcarrier per spatial stream, and is equal to the modulation order such as 1 for BPSK, 2 for QPSK, 4 for 16QAM, 6 for 64QAM, and 8 for 256QAM).

In a particular embodiment, the interleaver depth (e.g., the number of columns (N_{COL})) can be a factor of the number of data tones (N_{data}). Referring to FIG. 3, a 12 data tone block can have an interleaver depth of 2, 3, 4, or 6. A 36 data tone block can have an interleaver depth of 2, 3, 4, 6, 9, 12, or 18. A 72 data tone block can have an interleaver depth of 2, 3, 4, 6, 8, 9, 12, 18, 24, or 36. A 120 data tone block can have an interleaver depth of 2, 3, 4, 5, 6, 8, 10, 12, 15, 20, 24, 30, 40, or 60. A 156 data tone block can have an interleaver depth of 2, 3, 4, 6, 12, 13, 26, 39, 52, or 78. A 312 data tone block can have an interleaver depth of 2, 3, 4, 6, 8, 12, 13, 24, 26, 39, 52, 78, 104, or 156.

A frequency rotation can be applied to the spatial streams if there is more than one spatial stream. The frequency rotation can be based on a base subcarrier rotation (N_{ROT}) and a rotation index. The base subcarrier rotation (N_{ROT}) and the rotation index can be based on the number of data tones (N_{data}) and the number of spatial streams (N_{SS}).

For example, if the 12 data tone block has 4 or less spatial streams (N_{SS}), the base subcarrier rotation (N_{ROT}) can be 1, 2, 3, 4, 5, 6, or 7. The rotation index (e.g., the 6^{th} column of FIG. 3) can be 0, 2, 1, or 3 in this scenario. Alternatively, if the 12 data tone block has more than 4 spatial streams (N_{SS}), the base subcarrier rotation (N_{ROT}) can be 1, 2, 3, 4, 5, or 6. The rotation index (e.g., the 7^{th} column of FIG. 3) can be 0, 4, 2, 6, 1, 5, 3, or 7, or the rotation index can be chosen to maximize (or increase) an average subcarrier distance of adjacent streams.

If the 36 data tone block has 4 or less spatial streams (N_{SS}), the base subcarrier rotation (N_{ROT}) can be any integer within the inclusive range between 1 and 13 (e.g., 1-13). The rotation index can be 0, 2, 1, or 3 in this scenario. Alternatively, if the 36 data tone block has more than 4 spatial streams (N_{SS}), the base subcarrier rotation (N_{ROT}) can be any integer within the inclusive range between 1 and 9 (e.g., 1-9). The rotation index can be 0, 4, 2, 6, 1, 5, 3, or 7, or the rotation index can be chosen to maximize (or increase) an average subcarrier distance of adjacent streams.

If the 72 data tone block has 4 or less spatial streams (N_{SS}), the base subcarrier rotation (N_{ROT}) can be any integer within the inclusive range between 1 and 22 (e.g., 1-22). The rotation index can be 0, 2, 1, or 3 in this scenario. Alternatively, if the 72 data tone block has more than 4 spatial streams (N_{SS}), the base subcarrier rotation (N_{ROT}) can be any integer within the inclusive range between 1 and 13 (e.g., 1-13). The rotation index can be 0, 4, 2, 6, 1, 5, 3, or 7, or the rotation index can be chosen to maximize (or increase) an average subcarrier distance of adjacent streams.

If the 120 data tone block has 4 or less spatial streams (N_{SS}), the base subcarrier rotation (N_{ROT}) can be any integer within the inclusive range between 1 and 34 (e.g., 1-34). The rotation index can be 0, 2, 1, or 3 in this scenario. Alternatively, if the 120 data tone block has more than 4 spatial streams (N_{SS}), the base subcarrier rotation (N_{ROT}) can be any integer within the inclusive range between 1 and 19 (e.g., 1-19). The rotation index can be 0, 4, 2, 6, 1, 5, 3, or 7, or the rotation index can be chosen to maximize (or increase) an average subcarrier distance of adjacent streams.

If the 156 data tone block has 4 or less spatial streams (N_{SS}), the base subcarrier rotation (N_{ROT}) can be any integer within the inclusive range between 1 and 43 (e.g., 1-43). The rotation index can be 0, 2, 1, or 3 in this scenario. Alternatively, if the 156 data tone block has more than 4 spatial streams (N_{SS}), the base subcarrier rotation (N_{ROT}) can be any integer within the inclusive range between 1 and 24 (e.g., 1-24). The rotation index can be 0, 4, 2, 6, 1, 5, 3, or 7, or the rotation index can be chosen to maximize (or increase) an average subcarrier distance of adjacent streams.

If the 312 data tone block has 4 or less spatial streams (N_{SS}), the base subcarrier rotation (N_{ROT}) can be any integer within the inclusive range between 1 and 82 (e.g., 1-82). The rotation index can be 0, 2, 1, or 3 in this scenario. Alternatively, if the 312 data tone block has more than 4 spatial streams (N_{SS}), the base subcarrier rotation (N_{ROT}) can be any integer within the inclusive range between 1 and 43 (e.g., 1-43). The rotation index can be 0, 4, 2, 6, 1, 5, 3, or 7, or the rotation index can be chosen to maximize (or increase) an average subcarrier distance of adjacent streams.

Referring back to FIG. 2, the outputs of each interleaver 208a-208c (e.g., transmit streams) can be provided to the corresponding modulator 202a-202c. Each modulator 202a-202c can be configured to modulate the corresponding transmit stream and pass the modulated transmit stream to the corresponding transmission circuit 210a-210c. In a particular embodiment, the bits (e.g., the transmit streams) can be modulated using Quadrature Phase Shift Keying (QPSK) modulation, Binary Phase Shift Keying (BPSK) modulation, or Quadrature Amplitude Modulation (QAM) (e.g., 16-QAM, 64-QAM, 256-QAM). The transmission circuits 210a-210c can be configure to transmit the modulated transmit streams over a wireless network (e.g., an IEEE 802.11 wireless network) via the corresponding antennas 212a-212c.

In a particular embodiment, the antennas 212a-212c are distinct and spatially separated antennas. In another embodiment, distinct signal can be combined into different polarizations and transmitted via a subset of the antennas 212-212c. For example, the distinct signals can be combined where spatial rotation or spatial spreading is performed and multiple spatial streams are mapped to a single antenna.

The receive circuits 216a-216c of the destination device 129 can receive the interleaved encoded bits via the corresponding antennas 214a-214c. The outputs of the receive circuits 216a-216c are provided to the MIMO detector 218, and the output of the MIMO detector 218 is provided to the decoder 220. In a particular embodiment, the MIMO detector 218 can include a deinterleaving system configured to perform reverse operations of the interleaving system 114. The decoder 220 can output received bits which, without unrecoverable errors, are the same as the transmitted bits provided to the encoder 204.

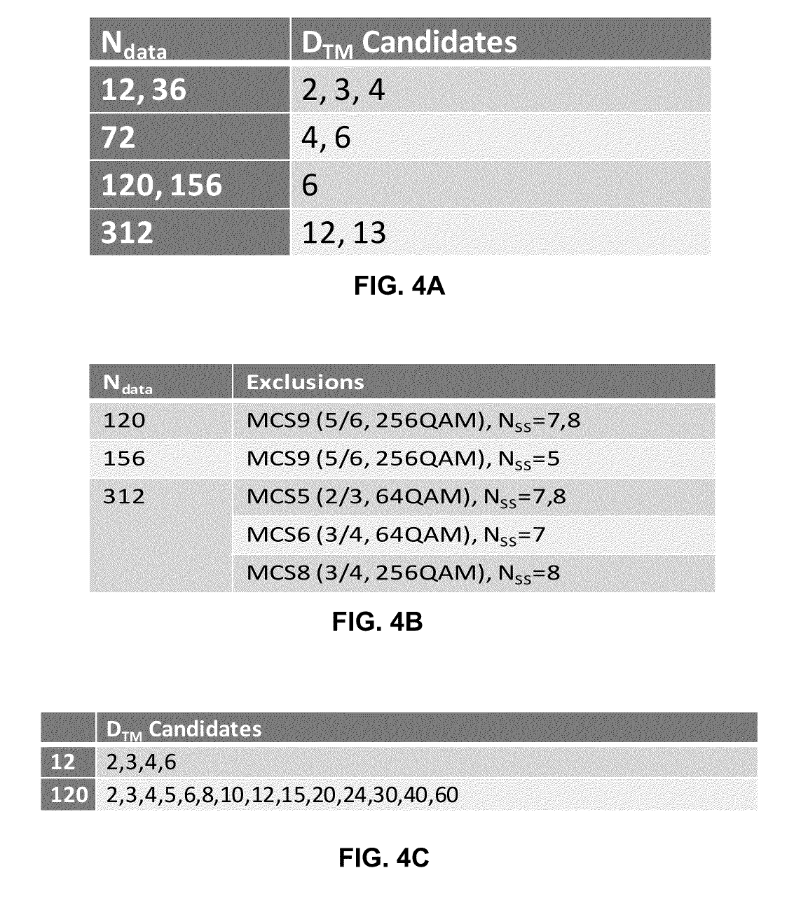

Referring to FIG. 4A, a chart illustrating a low density parity check (LDPC) tone mapping distance (D_{TM}) for different numbers of data tones (N_{data}) is shown. The mapping distance (D_{TM}) can be at least as large as the number of coded bits per OFDM symbol (N_{CBPS}) divided by the LDPC codeword length (L_{CW}) (e.g., N_{CBPS}/L_{Cw}≦D_{TM}). Additionally, the mapping distance (D_{TM}) can be an integer divisor of the number of subcarriers (N_{SD}). The mapping distance (D_{TM}) can be constant over rates within each bandwidth to enable a tone de-mapper implemented at a Fast Fourier Transform (FFT) module of the receive circuits 216a-216c with fixed tone processing.

The 12 data tone block and the 36 data tone block can have a mapping distance (D_{TM}) of 2, 3, or 4. The 72 data tone block can have a mapping distance (D_{TM}) of 4 or 6. The 120 data tone block and the 156 data tone block can have a mapping distance (D_{TM}) of 6. The 312 data tone block can have a mapping distance of 12 or 13.

Referring to FIG. 4B, a chart illustrating modulation and coding scheme (MCS) validity of the interleaver parameters is shown. The chart illustrates invalid MCS scenarios for MCSO-MCS9 for spatial streams up to eight spatial streams. With regards to BPSK modulation, QPSK modulation, 16-QAM, 64-QAM, and 256-QAM (hereinafter “the modulation schemes”), no exclusions can be present for the 12 data tone block, the 36 data tone block, or the 72 data tone block.

The 120 data tone block includes two exclusions (e.g., invalid MCS scenarios). For example, an invalid MCS can be present for the 120 data tone block having 7 spatial streams (NSS) using a 256-QAM modulation with an IEEE 802.11ac MCS9 scheme at a 5/6 data rate. Additionally, an invalid MCS can be present for the 120 data tone block having 8 spatial streams (NSS) using a 256-QAM modulation with an IEEE 802.11ac MCS9 scheme at a 5/6 data rate.

The 156 data tone block includes one exclusion. For example, an invalid MCS can be present for the 156 data tone block having 5 spatial streams (NSS) using a 256-QAM modulation with an IEEE 802.11ac MCS9 scheme at a 5/6 data rate.

The 312 data tone block includes four exclusions. For example, an invalid MCS can be present for the 312 data tone block having 7 spatial streams (NSS) using a 64-QAM modulation with an IEEE 802.11ac MCSS scheme at a 2/3 data rate. Additionally, an invalid MCS can be present for the 312 data tone block having 8 spatial streams (NSS) using a 64-QAM modulation with an IEEE 802.11ac MCSS scheme at a 2/3 data rate. An invalid MCS can be present for the 312 data tone block having 7 spatial streams (NSS) using a 64-QAM modulation with an IEEE 802.11ac MCS6 scheme at a 3/4 data rate. Additionally, an invalid MCS can be present for the 312 data tone block having 8 spatial streams (NSS) using a 256-QAM modulation with an IEEE 802.11ac MSCS scheme at a 3/4 data rate.

Referring to FIG. 4C, another chart illustrating a low density parity check (LDPC) tone mapping distance (D_{TM}) for different numbers of data tones (N_{data}) is shown. The mapping distance (D_{TM}) can be at least as large as the number of coded bits per OFDM symbol (N_{CBPS}) divided by the LDPC codeword length (L_{CW}) (e.g., N_{CSPS}/L_{CW}<D_{TM}). Additionally, the mapping distance (D_{TM}) can be an integer divisor of the number of subcarriers (N_{SD}). The mapping distance (D_{TM}) can be constant over rates within each bandwidth to enable a tone de-mapper implemented at a Fast Fourier Transform (FFT) module of the receive circuits 216a-216c with fixed tone processing.

In the illustrated embodiment, the 12 data tone block can have a mapping distance (D_{TM}) of 2, 3, 4, or 6. The 120 data tone block can have a mapping distance (D_{TM}) of 2, 3, 4, 5, 6, 8, 10, 12, 15, 20, 24, 30, 40, or 60. In various embodiments, the D_{TM} candidates shown in FIG. 4C can be combined with any tone plan, or aspect thereof, discussed herein (for example, the tone plans shown and discussed with respect to FIGS. 3 and 4A-4B).

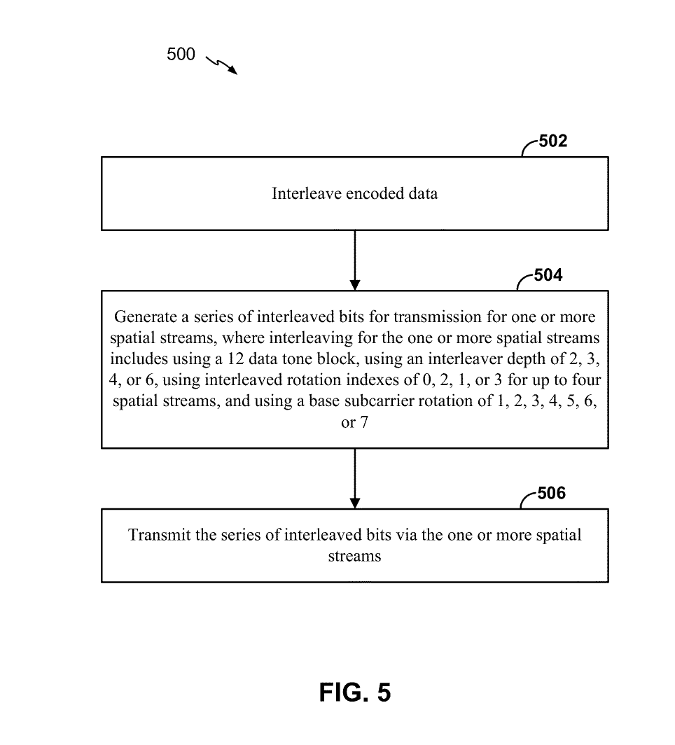

Referring to FIG. 5, a particular embodiment of method 500 for interleaving OFDMA data is shown. The method 500 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 500 includes interleaving encoded data, at 502. For example, referring to FIG. 2, the interleaving system 114 can interleave encoded data received from the encoder 204.

A series of interleaved bits for transmission can be generated for one or more spatial streams, at 504. For example, referring to FIG. 2, the interleaving system 114 can generate a series of interleaved bits for one or more spatial streams. Interleaving for the one or more spatial streams can include using a 12 data tone block, using an interleaver depth of 2, 3, 4, or 6, using interleaved rotation indexes of 0, 2, 1, or 3 for up to four spatial streams, and using a base subcarrier rotation of 1, 2, 3, 4, 5, 6, or 7.

The series of interleaved bits can be transmitted via the one or more spatial streams, at 506. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

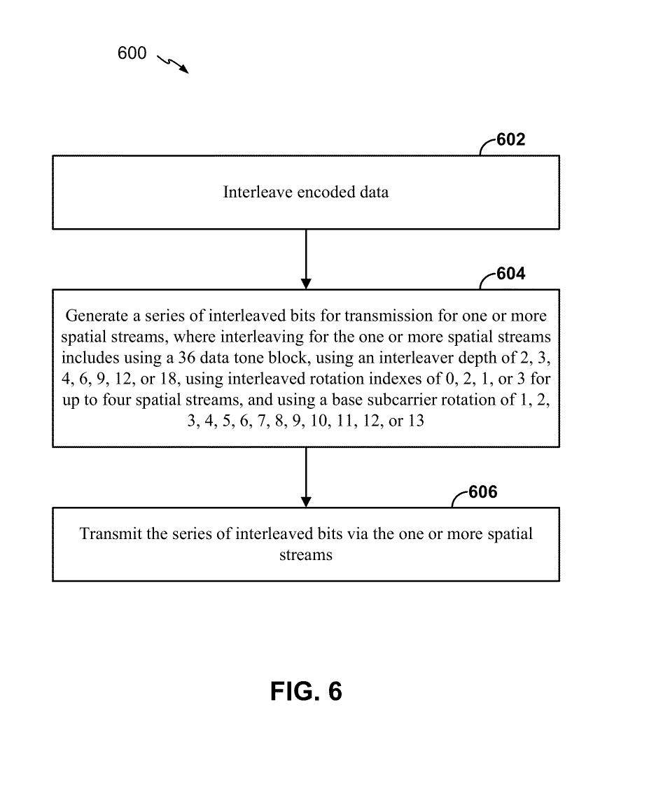

Referring to FIG. 6, another particular embodiment of method 600 for interleaving OFDMA data is shown. The method 600 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 600 includes interleaving encoded data, at 602. For example, referring to FIG. 2, the interleaving system 114 can interleave encoded data received from the encoder 204.

A series of interleaved bits for transmission can be generated for one or more spatial streams, at 604. For example, referring to FIG. 2, the interleaving system 114 can generate a series of interleaved bits for one or more spatial streams. Interleaving for the one or more spatial streams can include using a 36 data tone block, using an interleaver depth of 2, 3, 4, 6, 9, 12, or 18, using interleaved rotation indexes of 0, 2, 1, or 3 for up to four spatial streams, and using a base subcarrier rotation of 1, 2, 3, 4, 5, 6, 7, 8, 9, 10, 11, 12, or 13.

The series of interleaved bits can be transmitted via the one or more spatial streams, at 606. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

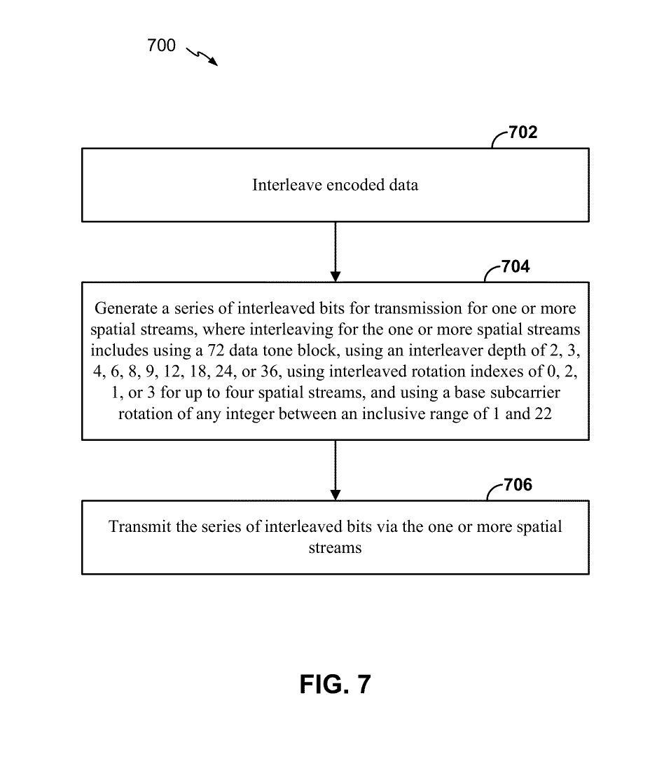

Referring to FIG. 7, another particular embodiment of method 700 for interleaving OFDMA data is shown. The method 700 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 700 includes interleaving encoded data, at 702. For example, referring to FIG. 2, the interleaving system 114 can interleave encoded data received from the encoder 204.

A series of interleaved bits for transmission can be generated for one or more spatial streams, at 704. For example, referring to FIG. 2, the interleaving system 114 can generate a series of interleaved bits for one or more spatial streams. Interleaving for the one or more spatial streams can include using a 72 data tone block, using an interleaver depth of 2, 3, 4, 6, 8, 9, 12, 18, 24, or 36, using interleaved rotation indexes of 0, 2, 1, or 3 for up to four spatial streams, and using a base subcarrier rotation of any integer between an inclusive range of 1 and 22.

The series of interleaved bits can be transmitted via the one or more spatial streams, at 706. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

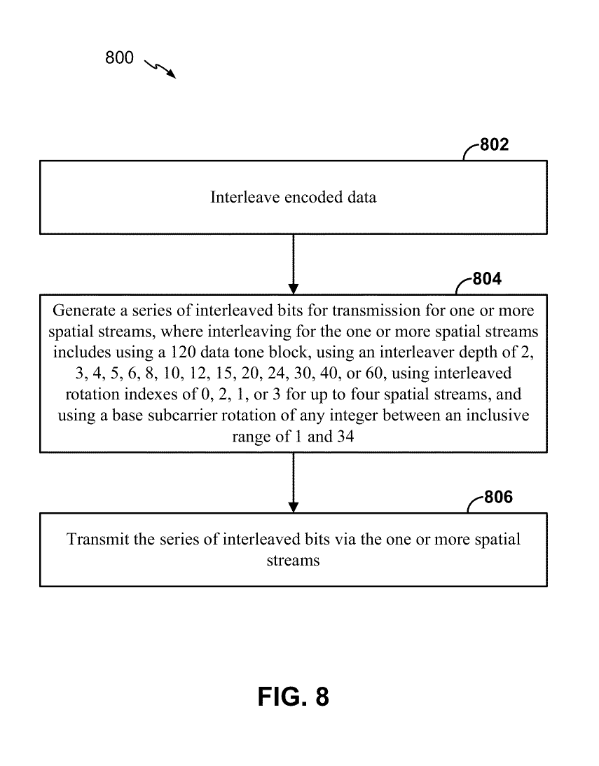

Referring to FIG. 8, another particular embodiment of method 800 for interleaving OFDMA data is shown. The method 800 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 800 includes interleaving encoded data, at 802. For example, referring to FIG. 2, the interleaving system 114 can interleave encoded data received from the encoder 204.

A series of interleaved bits for transmission can be generated for one or more spatial streams, at 804. For example, referring to FIG. 2, the interleaving system 114 can generate a series of interleaved bits for one or more spatial streams. Interleaving for the one or more spatial streams can include using a 120 data tone block, using an interleaver depth of 2, 3, 4, 5, 6, 8, 10, 12, 15, 20, 24, 30, 40, or 60, using interleaved rotation indexes of 0, 2, 1, or 3 for up to four spatial streams, and using a base subcarrier rotation of any integer between an inclusive range of 1 and 34.

The series of interleaved bits can be transmitted via the one or more spatial streams, at 806. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

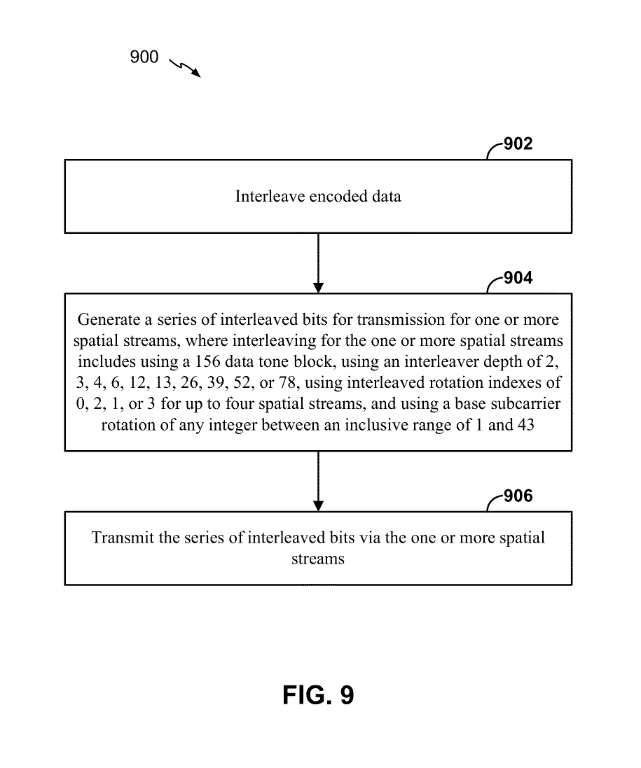

Referring to FIG. 9, another particular embodiment of method 900 for interleaving OFDMA data is shown. The method 900 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 900 includes interleaving encoded data, at 902. For example, referring to FIG. 2, the interleaving system 114 can interleave encoded data received from the encoder 204.

A series of interleaved bits for transmission can be generated for one or more spatial streams, at 904. For example, referring to FIG. 2, the interleaving system 114 can generate a series of interleaved bits for one or more spatial streams. Interleaving for the one or more spatial streams can include using a 156 data tone block, using an interleaver depth of 2, 3, 4, 6, 12, 13, 26, 39, 52, or 78, using interleaved rotation indexes of 0, 2, 1, or 3 for up to four spatial streams, and using a base subcarrier rotation of any integer between an inclusive range of 1 and 43.

The series of interleaved bits can be transmitted via the one or more spatial streams, at 906. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

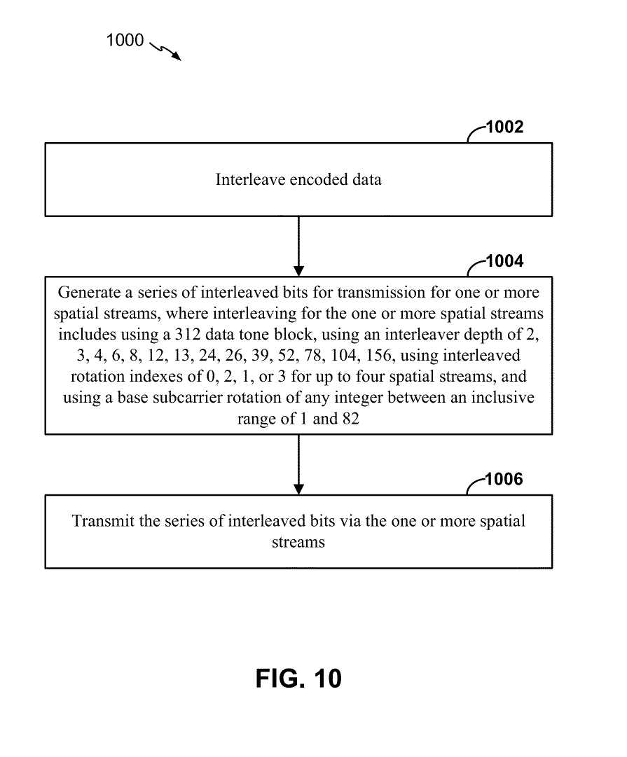

Referring to FIG. 10, another particular embodiment of method 1000 for interleaving OFDMA data is shown. The method 1000 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1000 includes interleaving encoded data, at 1002. For example, referring to FIG. 2, the interleaving system 114 can interleave encoded data received from the encoder 204.

A series of interleaved bits for transmission can be generated for one or more spatial streams, at 1004. For example, referring to FIG. 2, the interleaving system 114 can generate a series of interleaved bits for one or more spatial streams. Interleaving for the one or more spatial streams can include using a 312 data tone block, using an interleaver depth of 2, 3, 4, 6, 8, 12, 13, 24, 26, 39, 52, 78, 104, 156, using interleaved rotation indexes of 0, 2, 1, or 3 for up to four spatial streams, and using a base subcarrier rotation of any integer between an inclusive range of 1 and 82.

The series of interleaved bits can be transmitted via the one or more spatial streams, at 1006. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

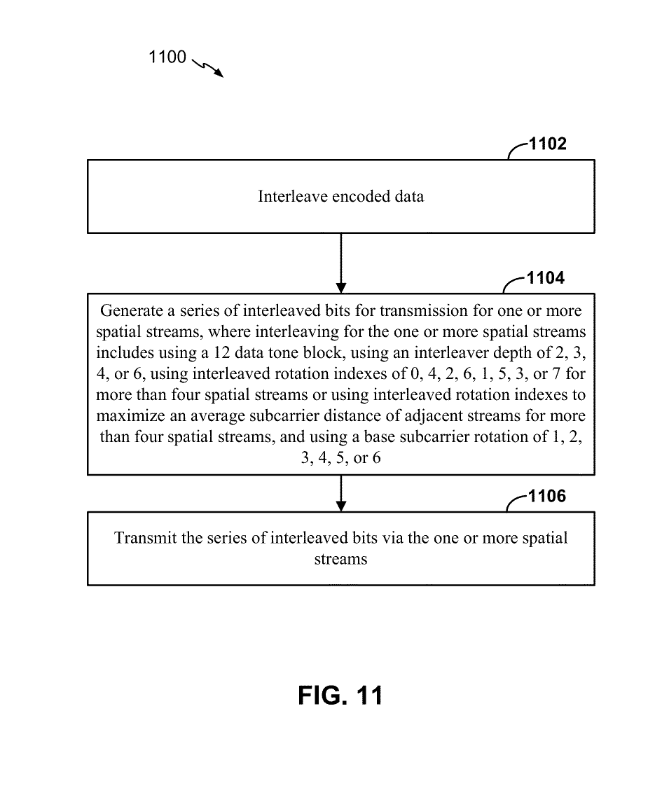

Referring to FIG. 11, a particular embodiment of method 1100 for interleaving OFDMA data is shown. The method 1100 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1100 includes interleaving encoded data, at 1102. For example, referring to FIG. 2, the interleaving system 114 can interleave encoded data received from the encoder 204.

A series of interleaved bits for transmission can be generated for one or more spatial streams, at 1104. For example, referring to FIG. 2, the interleaving system 114 can generate a series of interleaved bits for one or more spatial streams. Interleaving for the one or more spatial streams can include using a 12 data tone block, using an interleaver depth of 2, 3, 4, or 6, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, or 6. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1106. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

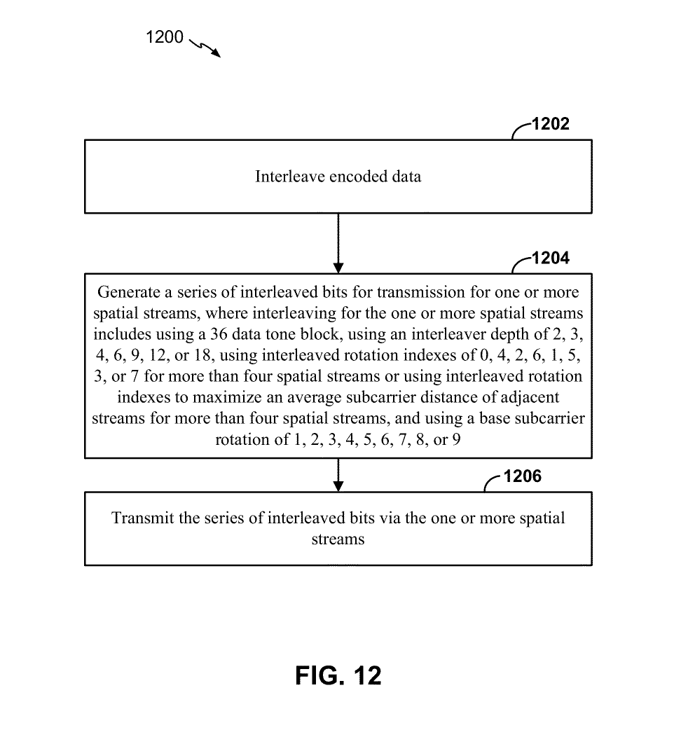

Referring to FIG. 12, another particular embodiment of method 1200 for interleaving OFDMA data is shown. The method 1200 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1200 includes interleaving encoded data, at 1202. For example, referring to FIG. 2, the interleaving system 114 can interleave encoded data received from the encoder 204.

A series of interleaved bits for transmission can be generated for one or more spatial streams, at 1204. For example, referring to FIG. 2, the interleaving system 114 can generate a series of interleaved bits for one or more spatial streams. Interleaving for the one or more spatial streams can include using a 36 data tone block, using an interleaver depth of 2, 3, 4, 6, 9, 12, or 18, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of 1, 2, 3, 4, 5, 6, 7, 8, or 9. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1206. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

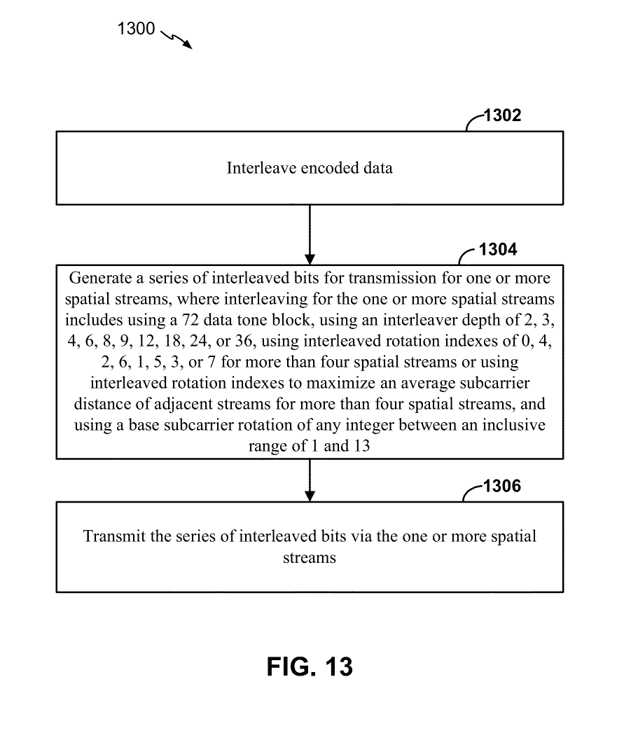

Referring to FIG. 13, another particular embodiment of method 1300 for interleaving OFDMA data is shown. The method 1300 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1300 includes interleaving encoded data, at 1302. For example, referring to FIG. 2, the interleaving system 114 can interleave encoded data received from the encoder 204.

A series of interleaved bits for transmission can be generated for one or more spatial streams, at 1304. For example, referring to FIG. 2, the interleaving system 114 can generate a series of interleaved bits for one or more spatial streams. Interleaving for the one or more spatial streams can include using a 72 data tone block, using an interleaver depth of 2, 3, 4, 6, 8, 9, 12, 18, 24, or 36, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 13. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1306. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

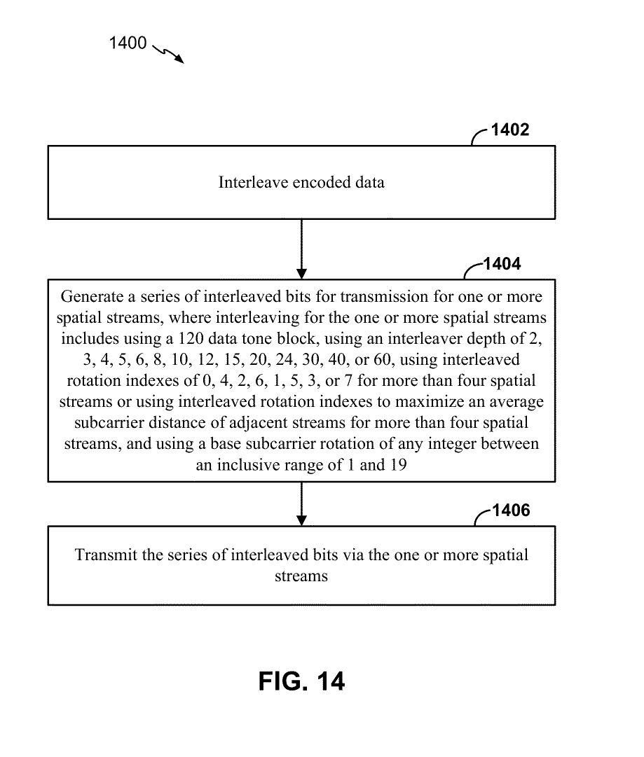

Referring to FIG. 14, another particular embodiment of method 1400 for interleaving OFDMA data is shown. The method 1400 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1400 includes interleaving encoded data, at 1402. For example, referring to FIG. 2, the interleaving system 114 can interleave encoded data received from the encoder 204.

A series of interleaved bits for transmission can be generated for one or more spatial streams, at 1404. For example, referring to FIG. 2, the interleaving system 114 can generate a series of interleaved bits for one or more spatial streams. Interleaving for the one or more spatial streams can include using a 120 data tone block, using an interleaver depth of 2, 3, 4, 5, 6, 8, 10, 12, 15, 20, 24, 30, 40, or 60, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 19. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1406. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

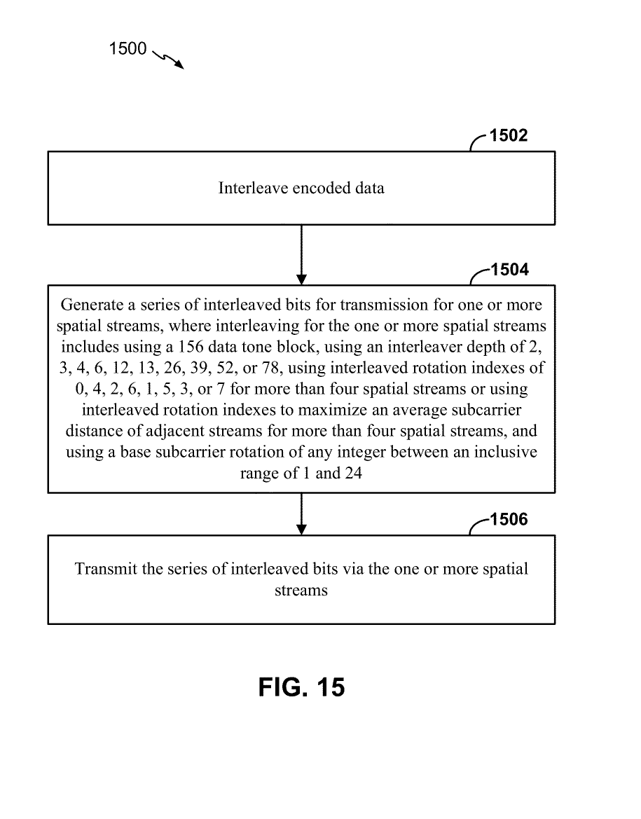

Referring to FIG. 15, another particular embodiment of method 1500 for interleaving OFDMA data is shown. The method 1500 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1500 includes interleaving encoded data, at 1502. For example, referring to FIG. 2, the interleaving system 114 can interleave encoded data received from the encoder 204.

A series of interleaved bits for transmission can be generated for one or more spatial streams, at 1504. For example, referring to FIG. 2, the interleaving system 114 can generate a series of interleaved bits for one or more spatial streams. Interleaving for the one or more spatial streams can include using a 156 data tone block, using an interleaver depth of 2, 3, 4, 6, 12, 13, 26, 39, 52, or 78, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 24. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1506. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

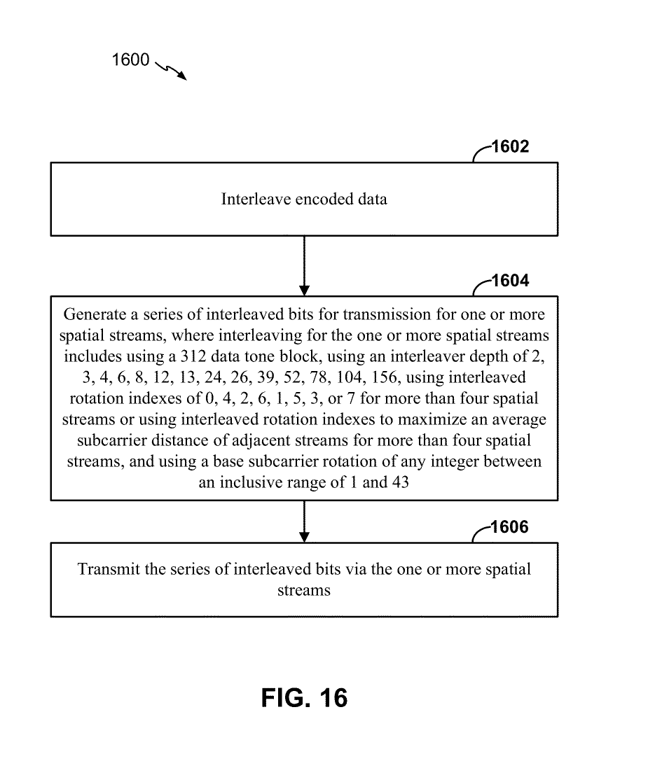

Referring to FIG. 16, another particular embodiment of method 1600 for interleaving OFDMA data is shown. The method 1600 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

The method 1600 includes interleaving encoded data, at 1602. For example, referring to FIG. 2, the interleaving system 114 can interleave encoded data received from the encoder 204.

A series of interleaved bits for transmission can be generated for one or more spatial streams, at 1604. For example, referring to FIG. 2, the interleaving system 114 can generate a series of interleaved bits for one or more spatial streams. Interleaving for the one or more spatial streams can include using a 312 data tone block, using an interleaver depth of 2, 3, 4, 6, 8, 12, 13, 24, 26, 39, 52, 78, 104, 156, using interleaved rotation indexes of 0, 4, 2, 6, 1, 5, 3, or 7 for 5, 6, 7, or 8 spatial streams or using interleaved rotation indexes to maximize (or increase) an average subcarrier distance of adjacent streams for 5, 6, 7, or 8 spatial streams, and using a base subcarrier rotation of any integer between an inclusive range of 1 and 43. As a non-limiting example, the interleaved rotation indexes to maximize (or increase) the average subcarrier distance of adjacent streams can be 0, 5, 2, 7, 3, 6, 1, or 4.

The series of interleaved bits can be transmitted via the one or more spatial streams, at 1606. For example, referring to FIG. 2, the series of interleaved bits can be transmitted using the transmission circuits 210a-210c and the antennas 212a-212c.

In various embodiments, said generating can include using a low density parity check (LDPC) tone mapping distance (DTM) of 2, 3, 4, or 6 for a 12 data tone block, a DTM of 2, 3, or 4 for a 36 data tone block, a DTM of 4 or 6 for a 72 data tone block, a DTM of 2, 3, 4, 5, 6, 8, 10, 12, 15, 20, 24, 30, 40, or 60 for a 120 data tone block, a DTM of 6 for a 156 data tone block, and/or a DTM of 12 or 13 for a 312 data tone block.

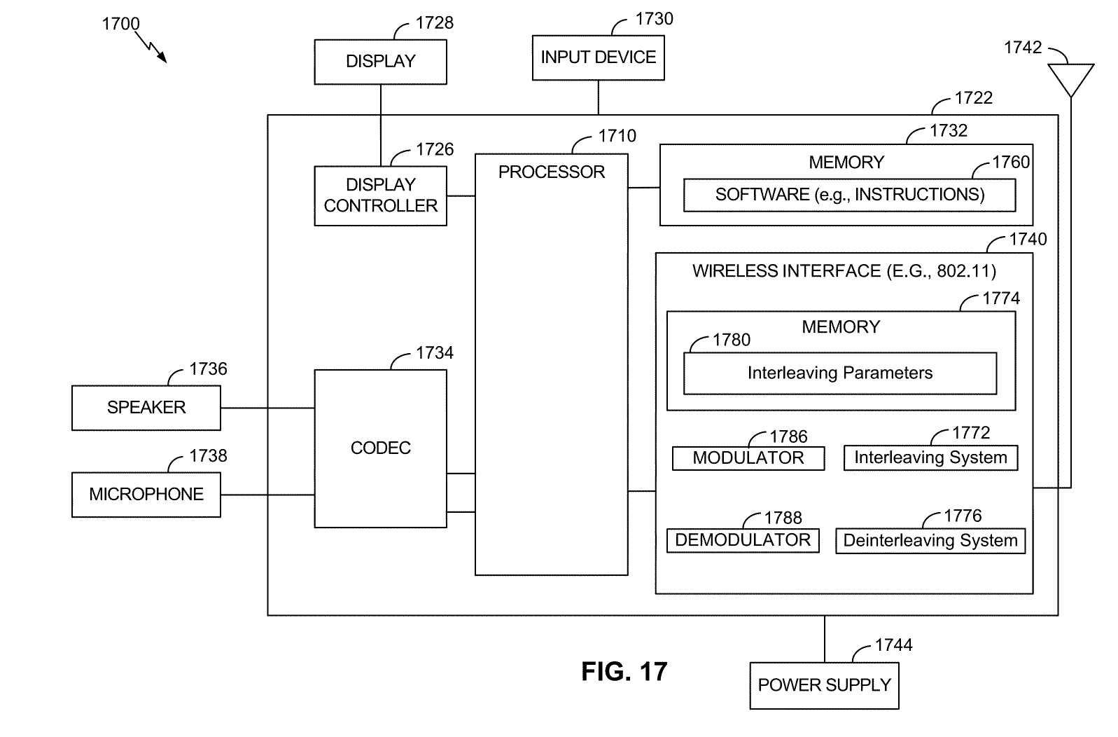

Referring to FIG. 17, a block diagram of a particular illustrative embodiment of a wireless communication device is depicted and generally designated 1700. The device 1700 can be a wireless electronic device and can include a processor 1710, such as a digital signal processor (DSP), coupled to a memory 1732. In an illustrative embodiment, the device 1700 can be one of the devices 110, 120, 130, or 140 of FIG. 1.

The processor 1710 can be configured to execute software 1760 (e.g., a program of one or more instructions) stored in the memory 1732. Additionally or alternatively, the processor 1710 can be configured to implement one or more instructions stored in a memory 1774 of a wireless interface 1740, as described further herein. In a particular embodiment, the processor 1710 can be configured to operate in accordance with one or more of operations or methods described with reference to FIGS. 1-16.

A wireless interface 1740 can be coupled to the processor 1710 and to an antenna 1742, such that wireless data received via the antenna 1742 and the wireless interface 1740 can be provided to the processor 1710. For example, the wireless interface 1740 can include or correspond to the wireless interface 115 of FIG. 1 or the wireless interface 125 of FIG. 1. The wireless interface 1740 can include the memory 1774, an interleaving system 1772 (e.g., the interleaving system 114 of FIG. 2), and a deinterleaving system 1776 (e.g., the deinterleaving system 124 of FIG. 1). The memory 1774 can include interleaving parameters 1780 (e.g., the interleaving parameters 113 or 123 of FIG. 1). In a particular embodiment, the wireless interface 1740 can also include a modulator 1786 and a demodulator 1788 for uplink and downlink communication, respectively. The interleaving system 1772 can be configured to interface with the processor 1710 to execute one or more instructions stored in the memory 1774. The deinterleaving system 1776 can also be configured to interface with the processor 1710 to execute one or more instructions stored in the memory 1774.

In a particular embodiment, the processor 1710, the display controller 1726, the memory 1732, the CODEC 1734, and the wireless interface 1740, are included in a system-in-package or system-on-chip device 1722. In a particular embodiment, an input device 1730 and a power supply 1744 are coupled to the system-on-chip device 1722. Moreover, in a particular embodiment, as illustrated in FIG. 17, the display device 1728, the input device 1730, the speaker 1736, the microphone 1738, the antenna 1742, and the power supply 1744 are external to the system-on-chip device 1722. However, each of the display device 1728, the input device 1730, the speaker 1736, the microphone 1738, the antenna 1742, and the power supply 1744 can be coupled to one or more components of the system-on-chip device 1722, such as one or more interfaces or controllers.

One or more of the disclosed embodiments can be implemented in a system or an apparatus, such as the device 1700, that can include a communications device, a fixed location data unit, a mobile location data unit, a mobile phone, a cellular phone, a satellite phone, a computer, a tablet, a portable computer, or a desktop computer.

Additionally, the device 1700 can include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, any other device that stores or retrieves data or computer instructions, or a combination thereof. As another illustrative, non-limiting example, the system or the apparatus can include remote units, such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof.

Although one or more of FIGS. 1-11 can illustrate systems, apparatuses, and/or methods according to the teachings of the disclosure, the disclosure is not limited to these illustrated systems, apparatuses, and/or methods. Embodiments of the disclosure can be suitably employed in any device that includes integrated circuitry including memory, a processor, and on-chip circuitry.

In conjunction with the described embodiments, an apparatus is disclosed that can include means for interleaving encoded data. For example, the means for interleaving the encoded data can include the interleaving system 114 of FIG. 1, the interleaving system 114 of FIG. 2 and the components thereof, the interleaving system 1772 of FIG. 17, one or more other devices, circuits, modules, or instructions to interleave the encoded data, or any combination thereof.

The apparatus also includes means for generating a series of interleaved bits for transmission for one or more spatial streams. For example, the means for generating the series of interleaved bits for transmission can include the interleaving system 114 of FIG. 1, the interleaving system 114 of FIG. 2 and the components thereof, the modulators 202a-202c of FIG. 2, the interleaving system 1772 of FIG. 17, the modulator 1786 of FIG. 17, one or more other devices, circuits, modules, or instructions to generate the series of interleaved bits, or any combination thereof.

The apparatus also includes means for transmitting the series of interleaved bits via the one or more spatial streams. For example, the means for transmitting the series of interleaved bits can include the wireless interface 115 of FIG. 1, the transmission circuits 210a-210c of FIG. 2, the antennas 212a-212c of FIG. 2, the antenna 1742 of FIG. 17, one or more other devices, circuits, modules, or instructions to transmit the series of interleaved bits, or any combination thereof.

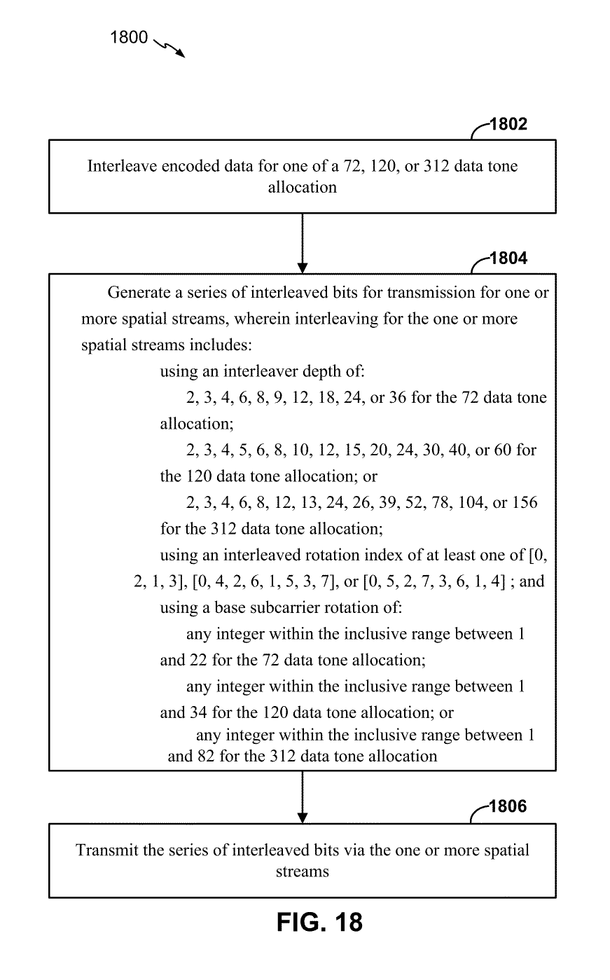

Referring to FIG. 18, a particular embodiment of method 1800 for interleaving OFDMA data is shown. The method 1800 can be performed by the interleaving system 114 of the first device 110 of FIGS. 1-2, or by any other device described herein. Although various method blocks are shown in a particular order, in other embodiments blocks can be rearranged, additional blocks can be added, and one or more blocks can be omitted.

In various embodiments, the numbers of certain data tones discussed herein (e.g., 12, 36, 72, 120, 156, and 312) can refer to interleaving performed across resource units (RUs) allocated to a single user. Thus, any combinations of numbers of data tones in RUs (e.g., 24 in a 26-tone RU, 48 in a 52-tone RU, 102 in a 106-tone RU, 234 in a 242-RU, 468 in a 484-tone RU, and 980 in a 996-tone RU) can be applied to the allocation sizes discussed herein in multiples. For example, three 24-tone RUs, or one 24-tone RU and one 48-tone RU, can form one 72 data tone allocation. As another example, five 24-tone RUs, one 48-tone RU plus three 24-tone RUs, or two 48-tone RUs plus one 24-tone RU, can form one 120 data tone allocation. Similarly, thirteen 24-tone RUs or six 48-tone RUs and one 24-tone RU can form one 312 data tone allocation (and so on).

The method 1800 includes interleaving encoded data for at least one of a 72, 120, or 312 data tone allocation, at 1802. For example, referring to FIG. 2, the interleaving system 114 can interleave encoded data received from the encoder 204. In various embodiments, interleaving can be performed as discussed herein with respect to FIGS. 7, 8, 10, 13, 14, and/or 16. In various embodiments, a tone allocation can include a total of 72, 120, or 312 data tone assigned to one user in one transmission. Each tone allocation can include a single resource unit (RU) (either in its entirety, or a portion thereof), or multiple RUs combined (for example, using channel bonding, puncturing, etc.). As contemplated in the present disclosure, systems and methods for interleaving encoded data for at least one of a 72, 120, or 312 data tone allocation can include interleaving just one allocation size (e.g., the system can be configured to interleave just 72 data tones, just 120 data tones, just 312 data tones), any combination of one or more allocation sizes (e.g., the system can be configured to interleave both 72 and 120 data tones, 72 and 312 data tones, and so on), or all allocation sizes (e.g., sequentially or simultaneously).

A series of interleaved bits for transmission can be generated for one or more spatial streams, at 1804. For example, referring to FIG. 2, the interleaving system 114 can generate a series of interleaved bits for one or more spatial streams. Interleaving for the one or more spatial streams can include using a 12 data tone block, using an interleaver depth of 2, 3, 4, 6, 8, 9, 12, 18, 24, or 36 for the 72 data tone allocation. Interleaving for the one or more spatial streams can include using a 12 data tone block, using an interleaver depth of 2, 3, 4, 5, 6, 8, 10, 12, 15, 20, 24, 30, 40, or 60 for the 120 data tone allocation. Interleaving for the one or more spatial streams can include using a 12 data tone block, using an interleaver depth of 2, 3, 4, 6, 8, 12, 13, 24, 26, 39, 52, 78, 104, or 156 for the 312 data tone allocation.

Interleaving for the one or more spatial streams can include using an interleaved rotation index of at least one of [0, 2, 1, 3], [0, 4, 2, 6, 1, 5, 3, 7], or [0, 5, 2, 7, 3, 6, 1, 4]. As used herein, an interleaved rotation index of [A, B, C, D] means that the subcarrier rotation is done in the way: N_ROT*[A, B, C, D] has 4 values, where each is the number of subcarriers in circular shift for the 4 streams. In the case of [0, 2, 1, 3], for example, the 1st stream does not have a shift because N_ROT*0=0. The 2nd stream circularly shifts 2*N_ROT subcarriers. The 3rd and 4th streams (if any) circularly shift N_ROT subcarriers and 3*N_ROT subcarriers, respectively.

Interleaving for the one or more spatial streams can include using a base subcarrier rotation of any integer within the inclusive range between 1 and 22 for the 72 data tone allocation. Interleaving for the one or more spatial streams can include using a base subcarrier rotation of any integer within the inclusive range between 1 and 34 for the 120 data tone allocation. Interleaving for the one or more spatial streams can include using a base subcarrier rotation of any integer within the inclusive range between 1 and 82 for the 312 data tone allocation. In various embodiments, the foregoing base subcarrier rotations can be used for transmission over up to four spatial streams.

In various embodiments, interleaving for the one or more spatial streams can include using a base subcarrier rotation for 5, 6, 7, or 8 spatial streams of any integer within the inclusive range between 1 and 13 for the 72 data tone allocation. Interleaving for the one or more spatial streams can include using a base subcarrier rotation for 5, 6, 7, or 8 spatial streams of any integer within the inclusive range between 1 and 19 for the 120 data tone allocation. Interleaving for the one or more spatial streams can include using a base subcarrier rotation for 5, 6, 7, or 8 spatial streams of any integer within the inclusive range between 1 and 43 for the 312 data tone allocation.

In various embodiments, the method can further include parsing the encoded data to each of the one or more stream interleavers. In various embodiments, the one or more stream interleavers include use an interleaved rotation index of [0, 2, 1, 3] for up to four spatial streams, and [0, 4, 2, 6, 1, 5, 3, 7] for 5, 6, 7, or 8 spatial streams (also referred to as a bit reversal). In various embodiments, the one or more stream interleavers include use an interleaved rotation index of [0, 2, 1, 3] for up to four spatial streams, and [0, 5, 2, 7, 3, 6, 1, 4] for 5, 6, 7, or 8 spatial streams. In various embodiments, the one or more stream interleavers include interleaved rotation indices that maximize an average subcarrier distance of adjacent streams.

The series of interleaved bits can be transmitted via the one or more spatial streams, at 1806. For example, referring to FIG. 2, the series of interleaved bits can be transmitted using the transmission circuits 210a-210c and the antennas 212a-212c.

In some embodiments, a low density parity check (LDPC) tone mapping distance (DTM) can be advantageously selected for values where on DTM=N_{data}/N_{COL}. Moreover, DTM can be selected for values such that that DTM increases as N_{data} increases. Accordingly, in one embodiment, method includes using a DTM of 4 or 6 for the 72 data tone allocation; 6 or 8 for the 120 data tone allocation; or 12 or 13 for the 312 data tone allocation.

In various embodiments, N_{ROW} can advantageously be selected proportional to N_{data}/N_{COL}, and N_{ROW} can increase as N_{data} increases. Thus, in some embodiments, the method can use an interleaver depth of 12 or 18 for the 72 data tone allocation. The method can use an interleaver depth of 15 or 20 for the 120 data tone allocation. The method can use an interleaver depth of or 12, 13, 24, or 26 for the 312 data tone allocation.

In various embodiments, for N_{SS} less than 4, N_{ROT} can advantageously be selected in the neighborhood of [floor(N_data/4)−2,ceil(N_data/4)+2]. Thus, in some embodiments, the method can use a base subcarrier rotation of any integer within the inclusive range between 16 and 20 for the 72 data tone allocation. The method can use a base subcarrier rotation of any integer within the inclusive range between 28 and 32 for the 120 data tone allocation. The method can use a base subcarrier rotation of any integer within the inclusive range between 76 and 80 for the 312 data tone allocation.

In various embodiments, for N_{SS} less than 4, N_{ROT} can more advantageously be selected in the neighborhood of N_data/4. Thus, in some embodiments, the method can use a base subcarrier rotation of 18 for the 72 data tone allocation. The method can use a base subcarrier rotation of 30 for the 120 data tone allocation. The method can use a base subcarrier rotation of 78 for the 312 data tone allocation.

In various embodiments, for N_{SS} of 5, 6, 7, or 8, N_{ROT} can advantageously be selected in the neighborhood of [floor(N_data/8)−2,ceil(N_data/8)+2]. Thus, in some embodiments, the method can use a base subcarrier rotation for 5, 6, 7, or 8 spatial streams of any integer within the inclusive range between 7 and 11 for the 72 data tone allocation. The method can use a base subcarrier rotation of any integer within the inclusive range between 13 and 17 for the 120 data tone allocation. The method can use a base subcarrier rotation of or any integer within the inclusive range between 37 and 41 for the 312 data tone allocation.

In various embodiments, for N_{SS} of 5, 6, 7, or 8, N_{ROT} can more advantageously be selected in the neighborhood of N_data/8. Thus, in some embodiments, the method can use a base subcarrier rotation for 5, 6, 7, or 8 spatial streams of 9 for the 72 data tone allocation. The method can use a base subcarrier rotation of 15 for the 120 data tone allocation. The method can use a base subcarrier rotation of 39 for the 312 data tone allocation.

In various embodiments, the method can further include excluding a modulation and coding scheme (MCS) number 5 when using 7 or 8 spatial streams, excluding an MCS number 6 when using 7 spatial streams, and excluding an MCS number 8 when using 8 spatial steams, for the 312 data tone allocation. In some embodiments, 8 spatial streams are advantageously used. Thus, in one embodiment, the method can use a modulation and coding scheme (MCS) exclusion of MCS8 and 8 spatial steams for the 312 data tone allocation.

In an aspect, the method shown in FIG. 18 can be implemented in a wireless device that can include an interleaving circuit, a generating circuit, and a transmitting circuit. Those skilled in the art will appreciate that a wireless device can have more components than the simplified wireless device described herein. The wireless device described herein includes only those components useful for describing some prominent features of implementations within the scope of the claims.

The interleaving circuit can be configured to interleave encoded data for at least one of a 72, 120, or 312 data tone allocation. In an aspect, the interleaving circuit can be configured to implement block 1802 of the flowchart 1800 (FIG. 18). The interleaving circuit can include one or more of the wireless interface 1740 (FIG. 17), the interleaving system 1772 (FIG. 17), the interleaving parameters 1780 (FIG. 17), the interleaving system 114 (FIG. 1), the interleavers 208a-208c (FIG. 2), any of the processors 1710 (FIG. 17) or 111 (FIG. 1), and the memory 112 (FIG. 1) or 1732 (FIG. 17). In some implementations, means for interleaving can include the interleaving circuit.

The generating circuit can be configured to generate the series of interleaved bits for transmission for one or more spatial streams, wherein interleaving for the one or more spatial streams comprises. In an aspect, the generating circuit can be configured to implement block 1804 of the flowchart 1800 (FIG. 18). The generating circuit can include one or more of the wireless interface 1740 (FIG. 17), the interleaving system 1772 (FIG. 17), the interleaving parameters 1780 (FIG. 17), the interleaving system 114 (FIG. 1), the interleavers 208a-208c (FIG. 2), any of the processors 1710 (FIG. 17) or 111 (FIG. 1), and the memory 112 (FIG. 1) or 1732 (FIG. 17). In some implementations, means for generating can include the generating circuit.

The transmitting circuit can be configured to transmit the series of interleaved bits via the one or more spatial streams. In an aspect, the transmitting circuit can be configured to implement block 1806 of the flowchart 1800 (FIG. 18). The transmitting circuit can include one or more of the wireless interface 1740 (FIG. 17), the antenna 1742 (FIG. 17), the modulator 1786 (FIG. 17), the wireless interface 115 (FIG. 1) the modulators 202a-202c (FIG. 2), the TX 210a-210c (FIG. 2), and the antennas 212a-212c (FIG. 2). In some implementations, means for transmitting can include the transmitting circuit.

Those of skill would further appreciate that the various illustrative logical blocks, configurations, modules, circuits, and algorithm steps described in connection with the embodiments disclosed herein can be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans can implement the described functionality in varying ways for each particular application, but such implementation decisions should not be interpreted as causing a departure from the scope of the present disclosure.

The steps of a method or algorithm described in connection with the embodiments disclosed herein can be embodied directly in hardware, in a software module executed by a processor, or in a combination of the two. A software module can reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium can be integral to the processor. The processor and the storage medium can reside in an application-specific integrated circuit (ASIC). The ASIC can reside in a computing device or a user terminal. In the alternative, the processor and the storage medium can reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein can be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus for wireless communication, comprising:
an interleaver configured to interleave encoded data for at least one of a 72, 120, or 312 data tone allocation, and generate a series of interleaved bits for transmission based on the interleaved encoded data, the interleaver comprising one or more stream interleavers corresponding to one or more spatial streams, wherein the one or more stream interleavers are configured to interleave the encoded data and generate the series of interleaved bits by using:
an interleaver depth of:
2, 3, 4, 6, 8, 9, 12, 18, 24, or 36 for the 72 data tone allocation;
2, 3, 4, 5, 6, 8, 10, 12, 15, 20, 24, 30, 40, or 60 for the 120 data tone allocation; or
2, 3, 4, 6, 8, 12, 13, 24, 26, 39, 52, 78, 104, or 156 for the 312 data tone allocation;
an interleaved rotation index of at least one of [0, 2, 1, 3], [0, 4, 2, 6, 1, 5, 3, 7], or [0, 5, 2, 7, 3, 6, 1, 4]; and
a base subcarrier rotation of:
any integer within the inclusive range between 1 and 22 for the 72 data tone allocation;
any integer within the inclusive range between 1 and 34 for the 120 data tone allocation; or
any integer within the inclusive range between 1 and 82 for the 312 data tone allocation; and
a transmission circuit configured to transmit the series of interleaved bits via the one or more spatial streams.

2. The apparatus of claim 1, wherein the transmission circuit includes one or more antennas.

3. The apparatus of claim 1, wherein the interleaver includes a stream parser configured to parse the encoded data to each of the one or more stream interleavers.

4. The apparatus of claim 1, wherein each 72, 120, or 312 data tone allocation is allocated to an individual destination device.

5. The apparatus of claim 1, wherein the one or more stream interleavers use an interleaved rotation index of [0, 2, 1, 3] for up to four spatial streams, and [0, 4, 2, 6, 1, 5, 3, 7] for 5, 6, 7, or 8 spatial streams.

6. The apparatus of claim 1, wherein the one or more stream interleavers include use an interleaved rotation index of [0, 2, 1, 3] for up to four spatial streams, and [0, 5, 2, 7, 3, 6, 1, 4] for 5, 6, 7, or 8 spatial streams.

7. The apparatus of claim 1, wherein the one or more stream interleavers include interleaved rotation indices that maximize an average subcarrier distance of adjacent streams.

8. The apparatus of claim 1, wherein said interleaver is further configured to use a low density parity check (LDPC) tone mapping distance (DTM) of: 4 or 6 for the 72 data tone allocation; 6 or 8 for the 120 data tone allocation; or 12 or 13 for the 312 data tone allocation.

9. The apparatus of claim 1, wherein the one or more stream interleavers include an interleaver depth of: 12 or 18 for the 72 data tone allocation; 15 or 20 for the 120 data tone allocation; or 12, 13, 24, or 26 for the 312 data tone allocation.

10. The apparatus of claim 1, wherein the one or more stream interleavers include a base subcarrier rotation for up to four spatial streams of:
any integer within the inclusive range between 1 and 22 for the 72 data tone allocation;
any integer within the inclusive range between 1 and 34 for the 120 data tone allocation; or
any integer within the inclusive range between 1 and 82 for the 312 data tone allocation.

11. The apparatus of claim 1, wherein the one or more stream interleavers include a base subcarrier rotation for 5, 6, 7, or 8 spatial streams of:
any integer within the inclusive range between 1 and 13 for the 72 data tone allocation;
any integer within the inclusive range between 1 and 19 for the 120 data tone allocation; or
any integer within the inclusive range between 1 and 43 for the 312 data tone allocation.

12. The apparatus of claim 1, wherein the one or more stream interleavers include a base subcarrier rotation for up to four spatial streams of:
any integer within the inclusive range between 16 and 20 for the 72 data tone allocation;
any integer within the inclusive range between 28 and 32 for the 120 data tone allocation; or
any integer within the inclusive range between 76 and 80 for the 312 data tone allocation.

13. The apparatus of claim 1, wherein the one or more stream interleavers include a base subcarrier rotation for 5, 6, 7, or 8 spatial streams of:
any integer within the inclusive range between 7 and 11 for the 72 data tone allocation;
any integer within the inclusive range between 13 and 17 for the 120 data tone allocation; or
any integer within the inclusive range between 37 and 41 for the 312 data tone allocation.

14. The apparatus of claim 1, wherein the one or more stream interleavers include a base subcarrier rotation for up to four spatial streams of: 18 for the 72 data tone allocation; 30 for the 120 data tone allocation; or 78 for the 312 data tone allocation.

15. The apparatus of claim 1, wherein the one or more stream interleavers include a base subcarrier rotation for 5, 6, 7, or 8 spatial streams of: 9 for the 72 data tone allocation; 15 for the 120 data tone allocation; or 39 for the 312 data tone allocation.

16. The apparatus of claim 1, wherein the interleaver is configured to exclude a modulation and coding scheme (MCS) number 5 when using 7 or 8 spatial streams, exclude an MCS number 6 when using 7 spatial streams, and exclude an MCS number 8 when using 8 spatial steams, for the 312 data tone allocation.

17. The apparatus of claim 1, wherein the interleaver is configured to use a modulation and coding scheme (MCS) exclusion of MCS8 and 8 spatial steams for the 312 data tone allocation.

18. A method of wireless communication comprising:
interleaving encoded data for at least one of a 72, 120, or 312 data tone allocation;
generating a series of interleaved bits for transmission for one or more spatial streams, wherein interleaving for the one or more spatial streams comprises:
using an interleaver depth of:
2, 3, 4, 6, 8, 9, 12, 18, 24, or 36 for the 72 data tone allocation;
2, 3, 4, 5, 6, 8, 10, 12, 15, 20, 24, 30, 40, or 60 for the 120 data tone allocation; or
2, 3, 4, 6, 8, 12, 13, 24, 26, 39, 52, 78, 104, or 156 for the 312 data tone allocation;
using an interleaved rotation index of at least one of [0, 2, 1, 3], [0, 4, 2, 6, 1, 5, 3, 7], or [0, 5, 2, 7, 3, 6, 1, 4]; and
using a base subcarrier rotation of:
any integer within the inclusive range between 1 and 22 for the 72 data tone allocation;
any integer within the inclusive range between 1 and 34 for the 120 data tone allocation; or
any integer within the inclusive range between 1 and 82 for the 312 data tone allocation; and
transmitting the series of interleaved bits via the one or more spatial streams.

19. A non-transitory computer-readable medium comprising instructions that, when executed by a processor, cause the processor to:
interleave encoded data for at least one of a 72, 120, or 312 data tone allocation;
generate a series of interleaved bits for transmission for one or more spatial streams, wherein interleaving for the one or more spatial streams comprises:
using an interleaver depth of:
2, 3, 4, 6, 8, 9, 12, 18, 24, or 36 for the 72 data tone allocation;
2, 3, 4, 5, 6, 8, 10, 12, 15, 20, 24, 30, 40, or 60 for the 120 data tone allocation; or
2, 3, 4, 6, 8, 12, 13, 24, 26, 39, 52, 78, 104, or 156 for the 312 data tone allocation;
using an interleaved rotation index of at least one of [0, 2, 1, 3], [0, 4, 2, 6, 1, 5, 3, 7], or [0, 5, 2, 7, 3, 6, 1, 4]; and using a base subcarrier rotation of:
any integer within the inclusive range between 1 and 22 for the 72 data tone allocation;
any integer within the inclusive range between 1 and 34 for the 120 data tone allocation; or
any integer within the inclusive range between 1 and 82 for the 312 data tone allocation; and
transmit the series of interleaved bits via the one or more spatial streams.

20. An apparatus for wireless communication, comprising:
means for interleaving encoded data for at least one of a 72, 120, or 312 data tone allocation;
means for generating a series of interleaved bits for transmission for one or more spatial streams, wherein interleaving for the one or more spatial streams comprises:
means for using an interleaver depth of:
2, 3, 4, 6, 8, 9, 12, 18, 24, or 36 for the 72 data tone allocation;
2, 3, 4, 5, 6, 8, 10, 12, 15, 20, 24, 30, 40, or 60 for the 120 data tone allocation; or
2, 3, 4, 6, 8, 12, 13, 24, 26, 39, 52, 78, 104, or 156 for the 312 data tone allocation;
means for using an interleaved rotation index of at least one of [0, 2, 1, 3], [0, 4, 2, 6, 1, 5, 3, 7], or [0, 5, 2, 7, 3, 6, 1, 4]; and means for using a base subcarrier rotation of:
any integer within the inclusive range between 1 and 22 for the 72 data tone allocation;
any integer within the inclusive range between 1 and 34 for the 120 data tone allocation; or
any integer within the inclusive range between 1 and 82 for the 312 data tone allocation; and
means for transmitting the series of interleaved bits via the one or more spatial streams.
